(19) United States
(12) Patent Application Publication
(10) Pub. No.: US 2007/0166096 A1
(43) Pub. Date: Jul. 19, 2007

(54) Joint assembly

(76) Inventors: Chong Kheng Lim, Hoffman Estates, IL (US); Alexander Goerg, Kriftel (DE); Jiri Pazdirek, Schaumburg, IL (US); Thomas Pazdirek, Troy, MI (US)

Correspondence Address: Dana Andrew Alden, 2122 York Road, Suite 180, Oak Brook, IL, 60523, US

(21) Appl. No.: 11/633,285

(22) Filed: Dec. 4, 2006

Related U.S. Application Data
(63) Continuation of application No. PCT/US05/19566, filed on Jun. 3, 2005.

(51) Int. Cl. F16C 11/00

(52) U.S. Cl. 403/50; 403/122; 277/635

(57) ABSTRACT

A joint assembly comprising a seal provided with a first retaining surface and a second retaining surface, a ball stud provided with a ball portion and a socket, wherein the socket is provided with a seal acceptor and a ball cooperating surface, wherein the ball portion of the ball stud is within the ball cooperating surface and a portion of the seal is within the seal acceptor, and a first and a second constricting element, wherein the first constricting element is held in place by the first retaining surface on the seal and the second constricting element is held in place by the second retaining surface on the seal.

### FIELD OF THE INVENTION

This invention relates to joint assemblies, and particularly to joint assemblies that are provided with a seal and a joint.

### BACKGROUND OF THE INVENTION

Joint assemblies are known in the art and include a seal and a joint, such as ball joints. The seal protects the joint from exposure to objects, chemicals, or the elements. In certain instances, joints must be maintained or operated in a lubricated environment. In such instances, a joint and a lubricant are usually located within a seal.

Often seals become damaged. If the damage is discovered, usually the seal can be replaced before damage occurs to the joint; however, replacement of the seal is a laborious and expensive process. Worst still, if the damage to the seal is not discovered, the joint usually becomes irreparably damaged from exposure or from the lubricant leaking out. If the joint becomes irreparably damaged, the entire joint assembly usually needs to be replaced. Consequently, damage to the seal is a leading cause for costly joint assembly replacement or repair.

The present invention is directed to overcoming this and other disadvantages inherent in prior joint assemblies.

### SUMMARY OF THE INVENTION

The scope of the present invention is defined solely by the appended claims, and is not affected to any degree by the statements within this summary. Briefly stated, a joint assembly comprising a seal provided with a first retaining surface and a second retaining surface, a ball stud provided with a ball portion and a socket, wherein the socket is provided with a seal acceptor and a ball cooperating surface, wherein the ball portion of the ball stud is within the ball cooperating surface and a portion of the seal is within the seal acceptor, and a first and a second constricting element, wherein the first constricting element is held in place by the first retaining surface on the seal and the second constricting element is held in place by the second retaining surface on the seal.

### BRIEF DESCRIPTION OF THE DRAWINGS

FIG. 1 depicts a sectional view of an embodiment of the seal.

FIG. 2 depicts a sectional view of an embodiment of the seal.

FIG. 3 depicts a sectional view of an embodiment of the seal in cooperation with a ball joint.

FIG. 4 depicts a sectional view of an embodiment of the seal.

FIG. 5 depicts a sectional view of an embodiment of the seal.

FIG. 6 depicts a sectional view of an embodiment of the seal.

FIG. 7 depicts a sectional view of an embodiment of the seal.

FIG. 8 depicts a sectional view of an embodiment of the seal.

FIG. 9 depicts a sectional view of an embodiment of the seal in cooperation with a ball joint.

FIG. 10 depicts a sectional view of an embodiment of the seal.

FIG. 11 depicts a sectional view of an embodiment of the seal.

FIG. 12 depicts a sectional view of an embodiment of the seal.

FIG. 13 depicts a sectional view of an embodiment of the seal.

FIG. 14 depicts a close-up sectional view of an embodiment of a constricting element having a first coil end inserted within a second coil end and retained therein through an interference fit.

FIG. 15 depicts a sectional view of an embodiment of the seal in cooperation with embodiments of the constricting element.

FIG. 16 depicts a sectional view of an embodiment of a joint FIG. 17 depicts a sectional view of an embodiment of a ball stud.

FIG. 18 depicts a partial sectional view of an embodiment of a seal guard.

FIG. 19 depicts a perspective view of a seal guard.

FIG. 20 depicts a sectional view of an embodiment of a seal guard in cooperation with an embodiment of a socket.

FIG. 21 depicts a sectional view of an embodiment of a seal guard in cooperation with an embodiment of a socket.

FIG. 22 depicts a sectional view of an embodiment of a seal guard in cooperation with an embodiment of a socket.

FIG. 23 depicts a close-up view of an embodiment of a seal guard in cooperation with an embodiment of a socket.

FIG. 24 depicts a close-up view of an embodiment of a seal guard in cooperation with an embodiment of a socket.

FIG. 25 depicts a profile view of an embodiment of a coupling member.

FIG. 26 depicts a perspective view of a coupling member.

FIG. 27 depicts a profile view of an embodiment of a coupling member.

FIG. 28 depicts a sectional view of a stem on an embodiment of a coupling member.

FIG. 29 depicts a sectional view of an embodiment of a coupling member in cooperation with embodiments of a seal guard, a seal, and a ball joint.

FIG. 30 depicts a sectional view of an embodiment of a coupling member in cooperation with embodiments of a seal guard, a seal, and a ball joint.

FIG. 31 depicts a sectional view of an embodiment of a coupling member in cooperation with embodiments of a seal guard, a seal, and a ball joint.

FIG. 32 depicts a sectional view of an embodiment of a coupling member in cooperation with embodiments of a seal guard, a seal, and a ball joint.

FIG. 33 depicts a profile view of an embodiment of a coupling member.

FIG. 34 depicts a partial sectional view of an embodiment of a coupling member.

FIG. 35 depicts a sectional view of embodiments of the grommets and a perspective view of a nut-disc assembly.

FIG. 36 depicts a partial sectional view of an embodiment of the coupling member in cooperation with embodiments of the grommets and a nut-disc assembly.

FIG. 37 depicts a profile view of an embodiment of a ball stud.

FIG. 38 depicts a sectional view of a ball portion on an embodiment of a ball stud.

FIG. 39 depicts a sectional view of a ball portion on an embodiment of a ball stud.

FIG. 40 depicts a profile view of a plurality of projections on an embodiment of a ball stud.

FIG. 41 depicts a profile view of a second stud element on an embodiment of a ball stud.

FIG. 42 depicts a profile view of a coupling surface on an embodiment of a ball stud.

FIG. 43 depicts a profile view of a first stud element and a second stud element on an embodiment of a ball stud.

FIG. 44 depicts a profile view of a second stud element on an embodiment of a ball stud.

FIG. 45 depicts a sectional view of an embodiment of a nut-grommet assembly.

FIG. 46 depicts a sectional view of a grommet of an embodiment of a nut-grommet assembly.

FIG. 47 depicts a sectional view of embodiments of a nut-grommet assembly in cooperation with an arm and an end on an embodiment of a coupling member.

FIG. 48 depicts a profile view of an end on an embodiment of a coupling member.

FIG. 49 depicts a close-up profile view of a threaded section and an unthreaded section on an embodiment of a coupling member.

FIG. 50 depicts a close up view of the locking thread on an embodiment of a coupling member.

FIG. 51 depicts a close up view of the locking threads cooperating with the threads of a nut body.

FIG. 52 depicts a close up view of the locking threads cooperating with the threads of a nut body.

FIG. 53 depicts a close up view of the Vee-shaped threads on an embodiment of a coupling member.

FIG. 54 depicts a close up view of the curved threads on an embodiment of a coupling member.

FIG. 55 depicts a close up view of the curved threads on an embodiment of a coupling member.

FIG. 56 depicts a close up view of the threaded section on an embodiment of a coupling member.

FIG. 57 depicts a bottom plain view of an end on an embodiment of the coupling member.

FIG. 58 depicts a profile view of an embodiment of a coupling member.

### DETAILED DESCRIPTION OF THE PRESENTLY PREFERRED EMBODIMENTS

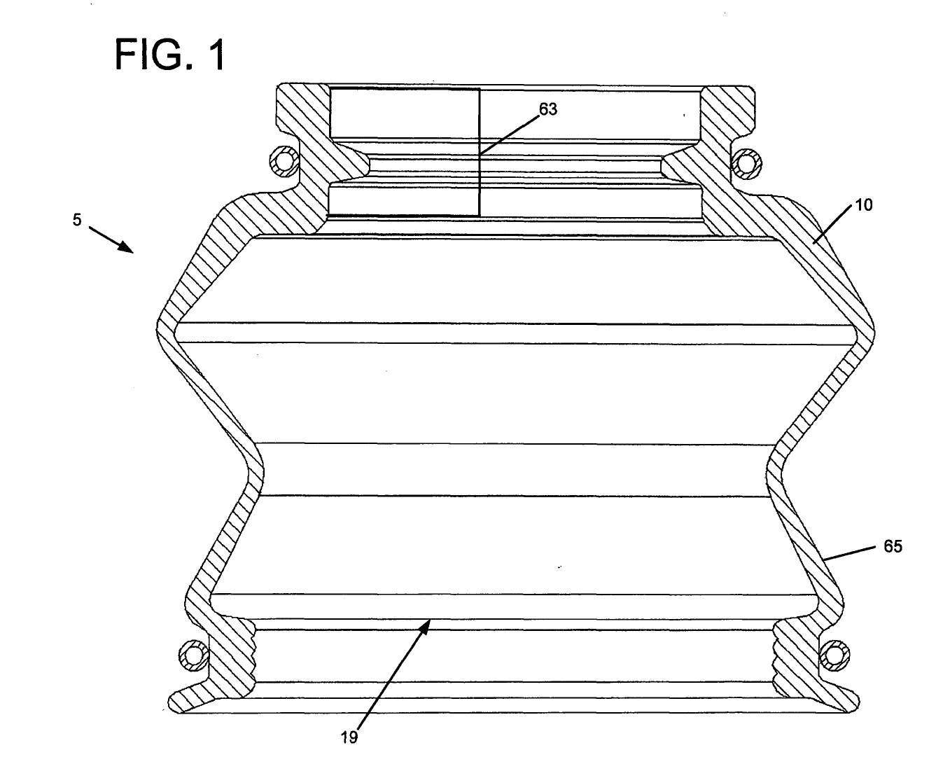

FIG. 1 depicts a joint assembly 5 provided with a seal 10 or boot 10 having an inner surface 19 and an outer surface 65. The seal 10 is made from a material, such as, for example, a vulcanized material, that provides resilience and is able to withstand temperatures exceeding 100° F. In the preferred embodiment the seal 10 is fabricated from neoprene rubber. In alternative embodiment, the seal 10 is fabricated from an elastomer, such as polyurethane.

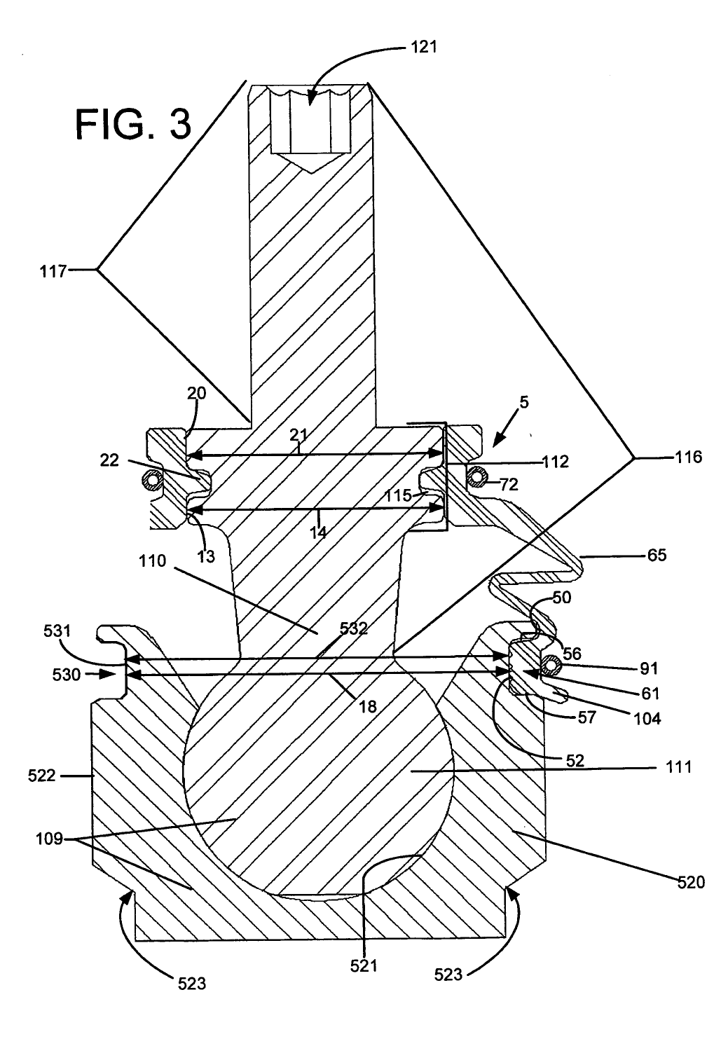

The inner surface 19 is configured to cooperate with a joint. In the preferred embodiment the inner surface 19 is configured to cooperate with a ball joint, such as, for example, ball joint 109 depicted in FIG. 3. According to another aspect of the present invention, the inner surface 19 is configured to cooperate with a shaft on a ball stud, such as, for example, the shaft 116 on ball stud 110 depicted in FIG. 3. According to yet another aspect of the present invention, the inner surface 19 is configured to cooperate with a socket, such as, for example, socket 520 on ball stud 109 depicted in FIG. 3.

Referring again to FIG. 1, the inner surface 19 of the seal 10 is provided with a shaft cooperating surface 63. According to one aspect, the shaft cooperating surface 63 is configured to retain the seal 10 on a ball stud 110 so that the seal 10 is capable of torsional movement with respect to the ball stud 110.

According to another aspect, the shaft cooperating surface 63 provides a seal for the lubricant within the inner surface 19. According to yet another aspect, the shaft cooperating surface 63 is configured to prevent seal wind-up and fatigue. According to yet another aspect, the shaft cooperating surface 63 is shape according to a shaft so that the seal 10 flexes at a predetermined flex area.

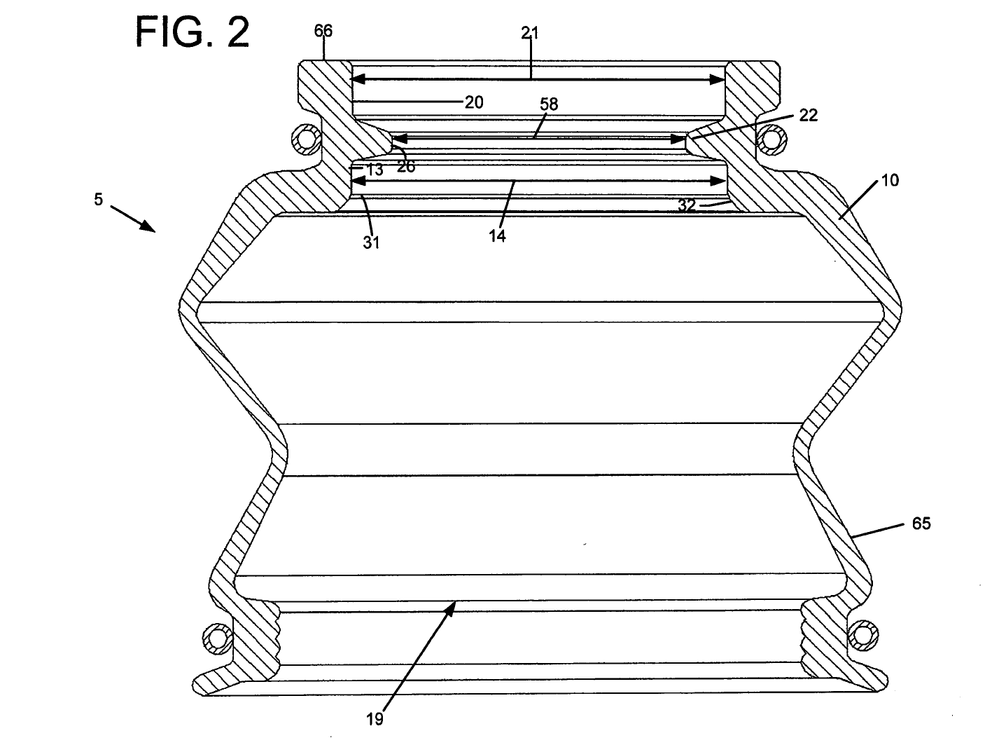

As shown in FIG. 2, the shaft cooperating surface 63 is provided with a first interface surface 20, a first securing member 22, and a second interface surface 13. The first interface surface 20 is configured to cooperate with a shaft, preferably a shaft 116 on a ball stud 110, as shown in FIG. 3, and is shaped correspondingly to the shaft 116, more specifically to a seal cooperating surface 112 located on the shaft 116.

As best depicted in FIG. 2, the first interface surface 20 of the preferred embodiment is cylindrical in shape. While FIG. 2 depicts a cylindrically shaped first interface surface 20, in an alternative embodiment, the first interface surface 20 is conical or frusto-conical in shape.

As shown in FIG. 2, the first interface surface 20 is provided with a diameter 21, which in the preferred embodiment is dimensioned according to a diameter of the shaft 116. In the preferred embodiment, the diameter 21 is dimensioned according to the seal cooperating surface 112 located on the shaft 116. Preferably, the diameter 21 is smaller than a diameter 114 (shown in FIG. 17) of the seal cooperating surface 112. As shown in FIG. 3 the diameter 21 elastically expands to accommodate a diameter 114 (shown in FIG. 17) of the seal cooperating surface 112.

As shown in FIG. 2, adjacent to the first interface surface 20 is a first securing member 22. The first securing member 22 is configured to cooperate with a shaft. As depicted in FIG. 3, in the preferred embodiment the first securing member 22 is configured to fit within a seal acceptor 115 located on the shaft 116.

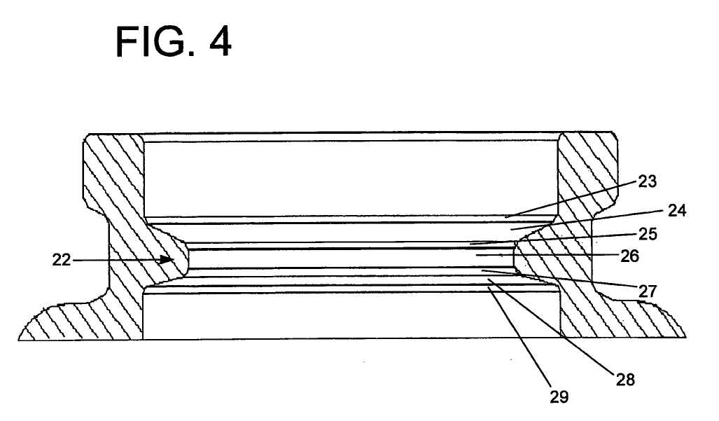

Referring now to FIG. 4, the first securing member 22 is provided with a first transitional surface 23. The first transitional surface 23 is shaped to provide the first securing member 22 with a tighter fit within the seal acceptor 115. As shown, the first transitional surface 23 is generally concave in shape.

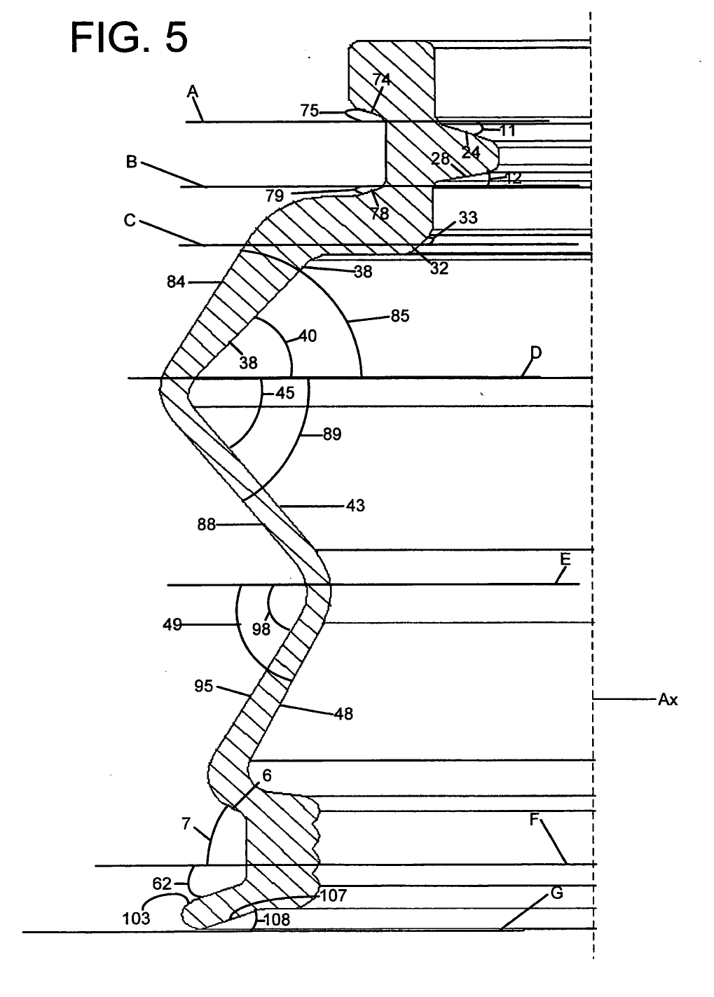

Adjacent to the first transitional surface 23 is a first inner frusto-conical surface 24. The first inner frusto-conical surface 24 is at an angle. As shown in FIG. 5, the first inner frusto-conical surface 24 is at an angle 11, with respect to imaginary line A, which runs perpendicular to an axis Ax of the seal 10. In the preferred embodiment, the angle 11 is 6°.

As shown in FIG. 4, the first inner frusto-conical surface 24 is located adjacent to a second transitional surface 25. The second transitional surface 25 is shaped to provide the first securing member 22 with a tighter fit within the seal acceptor 115. As shown in FIG. 4, the second transitional surface 24 is generally convex in shape.

Adjacent to the second transitional surface 25 is an inner cylindrical surface 26. As shown in FIG. 2, the inner cylindrical surface 26 is provided with a diameter 58. In the preferred embodiment, the diameter 58 of the inner cylindrical surface 26 is dimensioned to retain the seal 10 on the ball stud 110 and to provide a seal for the lubricant within the inner surface 19 of the seal 10. In the preferred embodiment, the diameter 58 of the inner cylindrical surface 26 is dimensioned according to a diameter 118 (shown in FIG. 17) of the seal acceptor 115 on the shaft 116, preferably smaller so that the first securing member 22 elastically fits around the shaft 116.

As shown in FIG. 4, adjacent to the inner cylindrical surface 26 is a third transitional surface 27. In the preferred embodiment, the third transitional surface 27 is shaped to provide the first securing member 22 with a tighter fit within the seal acceptor 115 on the shaft 116. As shown in FIG. 4, the third transitional surface 27 is generally convex in shape and is located adjacent to a second inner frusto-conical surface 28.

Referring now to FIG. 5, the second inner frusto-conical surface 28 is at an angle 12 with respect to imaginary line B, which runs perpendicular to the axis Ax of the seal 10. In the preferred embodiment, the angle 12 is 14°.

As shown in FIG. 4, located adjacent to the second inner frusto-conical surface 28 is a fourth transitional surface 29. The fourth transitional surface 29 is shaped to provide the first securing member 22 with a tighter fit within the seal acceptor 115. As shown in FIG. 4, the fourth transitional surface 29 is generally convex in shape.

While the first securing member 22 is depicted herein as including a plurality of surfaces, in an alternative embodiment, the first securing member 22 is made without the first transitional surface 23, the second transitional surface 25, the third transitional surface 27, or the fourth transitional surface 29.

Turning now to FIG. 2, located adjacent to the first securing member 22 is a second interface surface 13, which in the preferred embodiment is also configured to cooperate with the shaft 116. FIG. 3 depicts the second interface surface 13 shaped according to the seal cooperating surface 112 located on the shaft 116. As shown therein, the second interface surface 13 is cylindrical in shape. However, in an alternative embodiment, the second interface surface 13 is conical or frusto-conical in shape.

The second interface surface 13 is provided with a diameter 14. As shown in FIG. 3, the diameter 14 is dimensioned according to the shaft 116. In the preferred embodiment, the diameter 14 is dimensioned according to the seal cooperating surface 112 located on the shaft 116. Preferably, the diameter 14 is smaller than a diameter 120 (shown in FIG. 17) of the seal cooperating surface 112 so that the diameter 14 elastically expands to accommodate the diameter 120 of the seal cooperating surface 112.

As depicted in FIG. 2, located adjacent to the second interface surface 13 a fifth transitional surface 31. As shown in FIG. 2, the fifth transitional surface 31 is generally convex in shape. Although the presently preferred embodiment of the seal 10 is provided with a fifth transitional surface 31, the seal 10 of an alternative embodiment is fabricated without the fifth transitional surface 30.

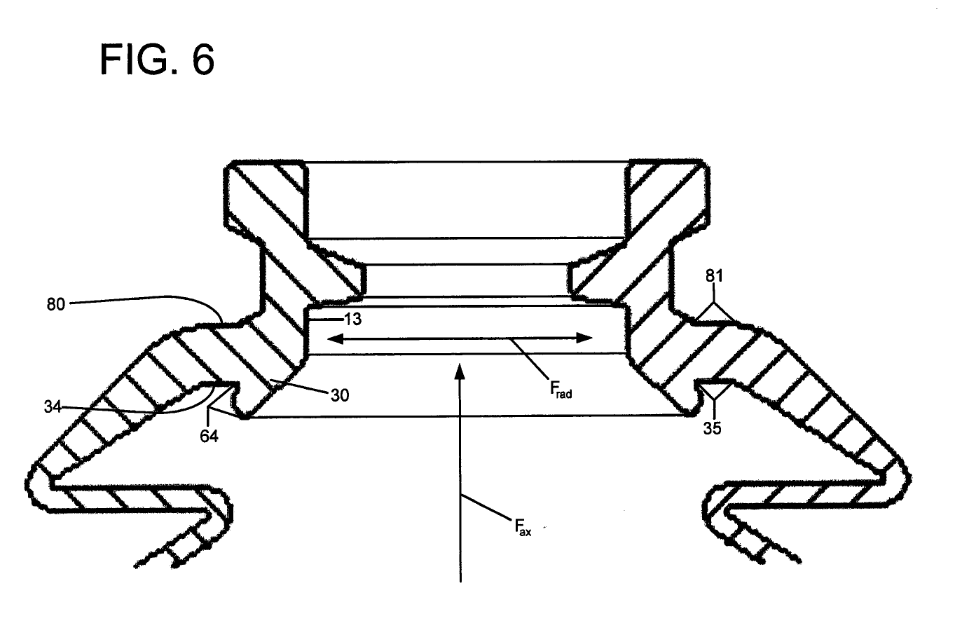

The presently preferred embodiment is provided with a first installation member 30, which is shown in FIG. 6. According to one aspect of the present invention, the first installation member 30 is shaped to cooperate with a shaft. In the preferred embodiment, the first installation member 30 is configured to cooperate with the shaft 116 located on a ball joint 109. According to another aspect of the present invention, the first installation member 30 is shaped to cooperate with the outer surface 65 of the seal 10. According to yet another aspect of the present invention, the first installation member 30 is shaped to cooperate with the first annular surface 66 (shown in FIG. 2).

As shown in FIG. 6, the first installation member 30 is provided with an overhang 64. During installation, the first installation member 30 translates an axial force Fₐₓ into a radial force F_{rad} so that at least one of the diameters 14, 21, and 58 (shown in FIG. 2) of the shaft cooperating surface 69 is increased.

While the presently preferred embodiment is shown with a first installation member 30 that provides greater ease in installing the seal 10, in an alternative embodiment, the seal 10 is fabricated without the first installation member 30. By way of example, in the embodiment depicted in FIG. 2, adjacent to the fifth transitional surface 31 is a sliding surface 32. As shown in FIG. 5, the sliding surface 32 is at an angle 33 with respect to an imaginary line C, which runs perpendicular to an axis Ax of the seal 10. In the preferred embodiment, angle 33 is 30°.

As shown in FIG. 6, the seal 10 is preferably provided with an inner corresponding surface 34 configured to cooperate with the outer surface 65. As depicted therein, the inner corresponding surface 34 is in a plane generally parallel to the outer corresponding surface 80 so that, after fabrication, the seal 10 shrinks uniformly during cooling. In the preferred embodiment, the inner corresponding surface 34 is generally annular, extending a radial distance 35 that corresponds to the radial distance 81 of the outer corresponding surface 80.

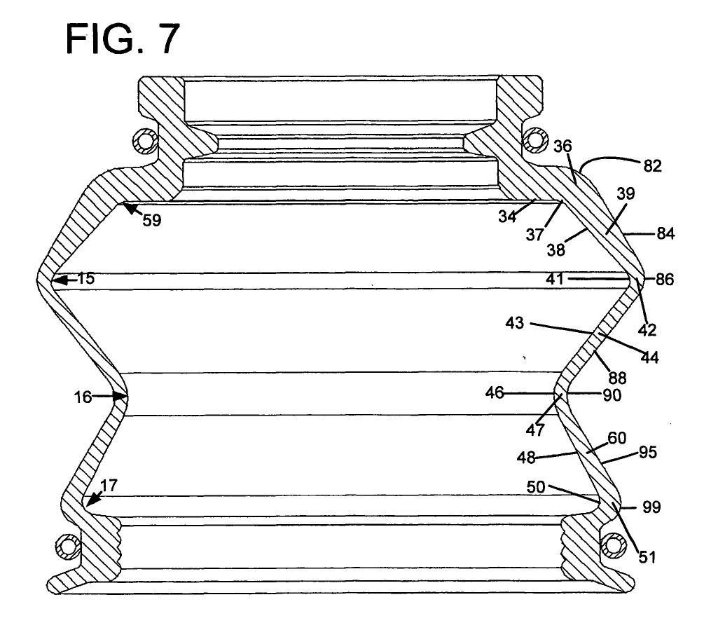

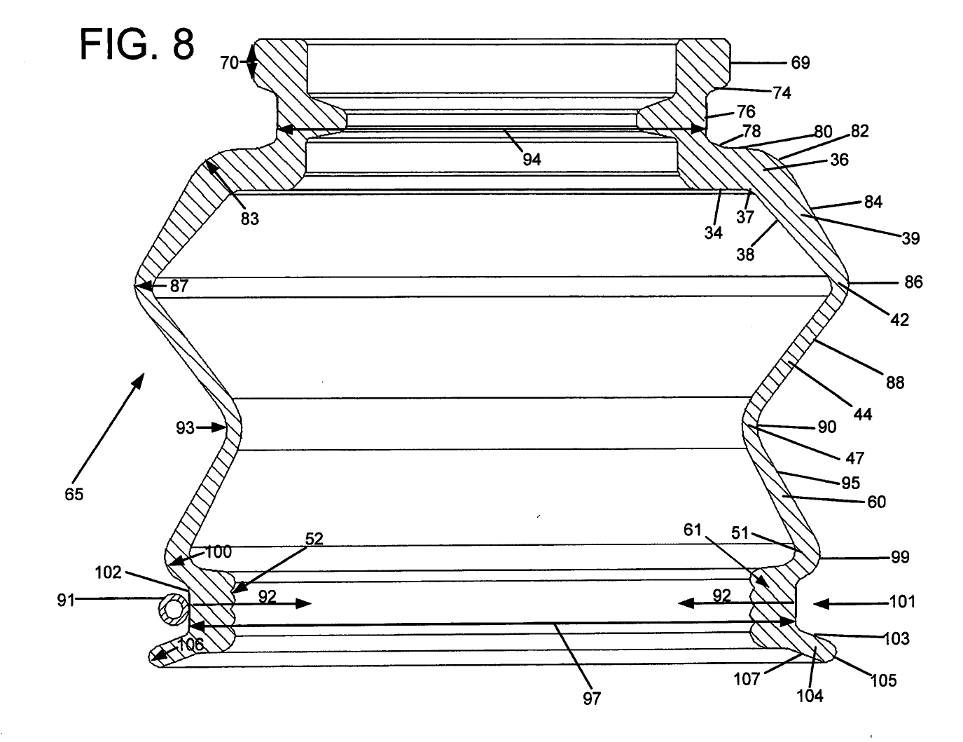

Referring now to FIG. 7, the seal 10 is provided with a first flex area 36. The first flex area 36 is shaped so that the seal 10 bends at flex area 36. In the preferred embodiment, the first flex area 36 includes cooperating curved surfaces, which, in FIG. 7, are depicted as a first inner curved surface 37 and a first outer curved surface 82. The first outer curved surface 82 and the first inner curved surface 37 are shaped cross-sectionally as arcs of imaginary circles. As shown in FIG. 8, the imaginary circle corresponding to the first outer curved surface 82 has a radius 83 preferably measuring 2.5 cm. As shown in FIG. 7, the imaginary circle corresponding to the first inner curved surface 37 has a radius 59 preferably measuring 0.5 cm.

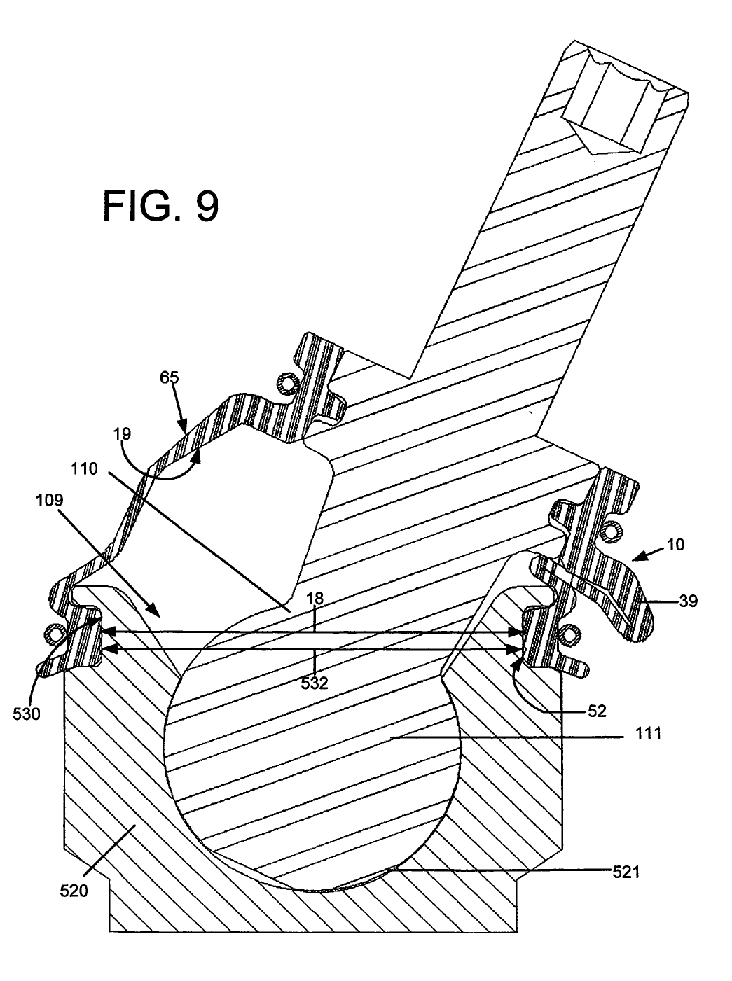

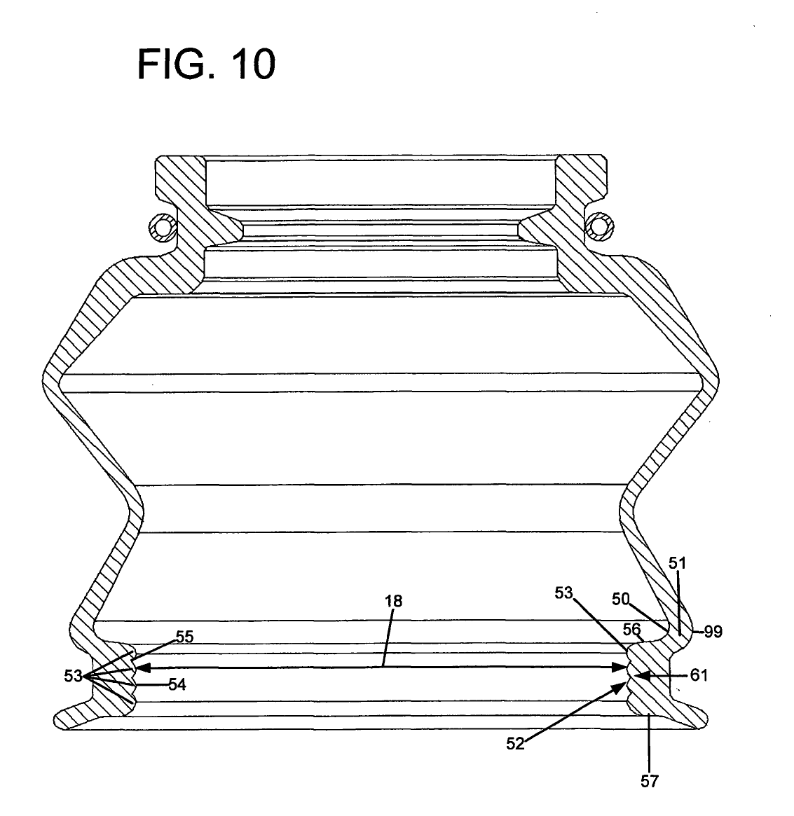

The seal 10 is provided with a plurality of seal portions 39, 44, and 60 having predetermined lengths, dimensioned according to the range of motion of the ball stud 110. Referring to FIG. 7, adjacent to the first flex area 36 is a first seal portion 39 that is formed with first inner and first outer angled surfaces, designated as 38 and 84 in FIG. 7, respectively. The first inner angled surface 38 and the first outer angled surface 84 are configured to cooperate with each other. As shown in FIG. 7, the first inner angled surface 38 and the first outer angled surface 84 are shaped so that the first seal portion 39 is tapered. As shown in FIG. 9, the first seal portion 39 is tapered so that, when a portion of the seal 10 compresses axially, the seal 10 extends radially from the ball stud 110.

Referring now to FIG. 5, the first inner angled surface 38 and the first outer angled surface 84 are depicted in greater detail. As shown therein, the first inner angled surface 38 and the first outer angled surface 84 are at an angle with respect to imaginary line D, which runs perpendicular to the axis Ax of the seal 10. The angle corresponding to the first inner angled surface 38, designated angle 40 in FIG. 5, measures 51°, while the angle corresponding to the first outer angled surface 84, designated angle 85 in FIG. 5, measures 60°.

Referring again to FIG. 7, a second flex area 42 is shown adjacent to the first seal portion 39. The second flex area 42 is shaped so that the seal 10 bends at flex area 42. In the preferred embodiment, the second flex area 42 includes cooperating curved surfaces, shown in FIG. 7 as a second inner curved surface 41 and a second outer curved surface 86. The second outer curved surface 86 and the second inner curved surface 86 are shaped cross-sectionally as arcs of imaginary circles. As shown in FIG. 8, the imaginary circle corresponding to the second outer curved surface 86 has a radius 87 preferably measuring 1.5 cm. As shown in FIG. 7, the imaginary circle corresponding to the second inner curved surface 41 has a radius 15 preferably measuring 0.5 cm.

Adjacent to the second flex area 42 is a second seal portion 44 that is formed with second inner and outer surfaces, designated 43 and 88 in FIG. 7, respectively. The second inner angled surface 43 and the second outer angled surface 88 are configured to cooperate with each other. The second inner angled surface 43 and the second outer angled surface 88 are shaped so that the second seal portion 44 is provided with a uniform thickness. As shown in FIG. 5, the second inner angled surface 43 and the second outer angled surface 88 are at an angle with respect to imaginary line D, which runs perpendicular to the axis Ax of the seal 10. The angle corresponding to the second inner angled surface 43, designated angle 45 in FIG. 5, and the angle corresponding to the second outer angled surface 88, designated 89 in FIG. 5, both measure 50°.

Adjacent to the second seal portion 44 is a third flex area 47. The third flex area 47 is shaped so that the seal 10 bends at flex area 47. In the preferred embodiment, the third flex area 47 includes cooperating curved surfaces, shown in FIG. 7 as a third inner curved surface 46 and a third outer curved surface 90. The third outer curved surface 90 and the third inner curved surface 46 are shaped cross-sectionally as arcs of imaginary circles. As shown in FIG. 8, the imaginary circle corresponding to the third outer curved surface 90 has a radius 93 preferably measuring 1.5 cm. As shown in FIG. 7, the imaginary circle corresponding to the third inner curved surface 46 has a radius 16 preferably measuring 2.50 cm.

Adjacent to the third flex area 47 is a third seal portion 60 that is formed with third inner and third outer angled surfaces, designated as 48 and 95 in FIG. 7, respectively. The third inner angled surface 48 and the third outer angled surface 95 are configured to cooperate with each other. The third inner angled surface 48 and the third outer angled surface 95 are shaped so that the third seal portion 60 is tapered.

Referring now to FIG. 5, the third inner angled surface 48 and the third outer angled surface 95 are depicted. As shown therein, the third inner angled surface 48 and the third outer angled surface 95 are at angles 49 and 98 with respect to imaginary line E, which runs perpendicular to the axis Ax of the seal 10. The angle corresponding to the third inner angled surface 48, designated angle 49 in FIG. 5, measures 62°, while the angle corresponding to the third outer angled surface 95, designated angle 98 in FIG. 5, measures 61°.

In FIG. 7, a fourth flex area 51 is shown adjacent to the third seal portion 60. The fourth flex area 51 is shaped so that the seal 10 bends at flex area 51. In the preferred embodiment, the fourth flex area 51 includes cooperating curved surfaces shown in FIG. 7 as a fourth inner curved surface 50 and a fourth outer curved surface 99. The fourth outer curved surface 99 and the fourth inner curved surface 50 are shaped cross-sectionally as arcs of imaginary circles. As shown in FIG. 8, the imaginary circle corresponding to the fourth outer curved surface 99 has a radius 100 preferably measuring 1.25 cm. As shown in FIG. 7, the imaginary circle corresponding to the fourth inner curved surface 50 has a radius 17 preferably measuring 0.75 cm.

Turning now to FIG. 10, adjacent to the fourth flex area 51 is a second securing member 61. In the preferred embodiment, the second securing member 61 is configured to cooperate with a socket, such as socket 520 depicted in FIG. 3. As shown in FIG. 3, the second securing member 61 is configured to fit within a seal acceptor 530 provided on the socket 520.

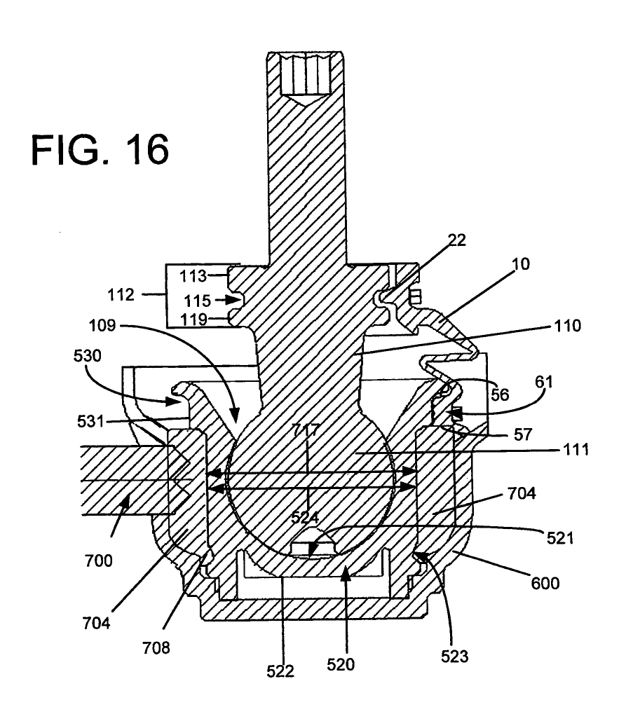

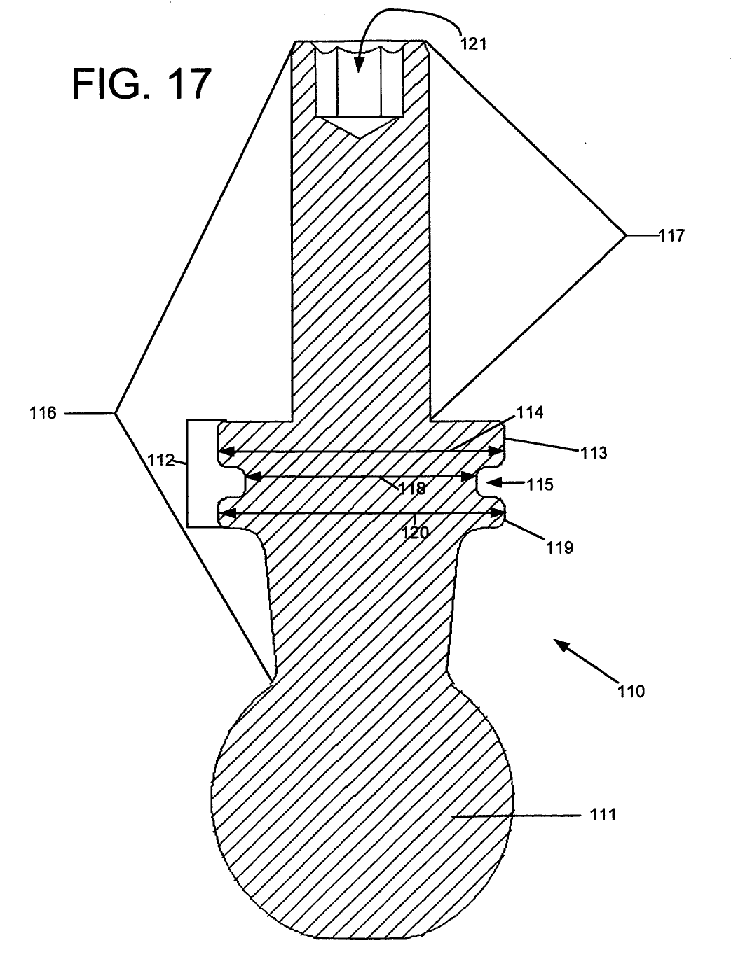

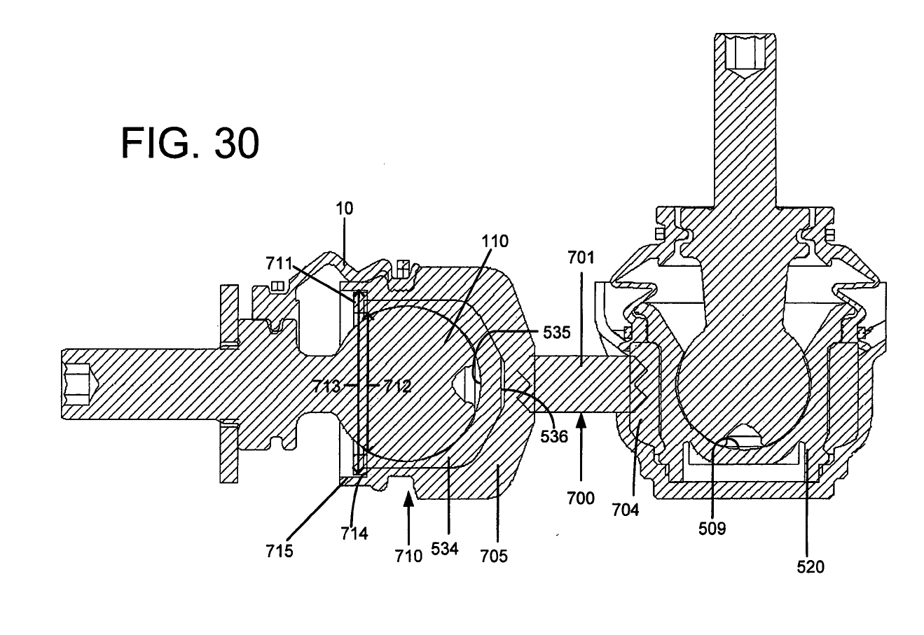

As depicted in FIG. 16, in an alternative embodiment, the second securing member 61 is configured to cooperate with a seal acceptor 530 on a socket 520 and a first end 704 of a coupling member 700. As depicted in FIG. 30, another alternative embodiment, the second securing member is configured to cooperate with a seal acceptor 710 provided on a second end 705 of a coupling member 700.

Referring now to FIG. 10, the second securing member 61 is provided with a plurality of sealing surfaces. In the preferred embodiment, the second securing member 61 is provided with a first sealing surface 52. In the preferred embodiment, the first sealing surface 52 is configured to cooperate with a socket 520. As shown in FIG. 3, the first sealing surface 52 is shaped to fit within a seal acceptor 530 provided on the socket 520.

In an alternative embodiment, the first sealing surface 52 is shaped to fit within a seal acceptor 710 on the second end 705 of a coupling member 700. In an alternative embodiment, the first sealing surface 52 is shaped to fit within a seal acceptor 530 on a socket 520 and a first end 704 of a coupling member 700.

In the preferred embodiment, the first sealing surface 52 is shaped to grip a cylindrical acceptor surface 531 that is provided on the seal acceptor 530. Advantageously, the first sealing surface 52 is provided with a surface shaped to have an increased frictional coefficient relative to a smooth surface. As shown in FIG. 10, in the preferred embodiment, the first sealing surface 52 is provided with one or more undulations 53. As shown therein, the first sealing surface 52 is provided with four (4) undulations 53. The undulations 53 are generally convex in shape and are provided with an apex 54. As depicted in FIG. 1, the undulations 53 are spaced from each other by a valley 55.

As best depicted in FIG. 10, the first sealing surface 52 is provided with a diameter 18. As shown in FIG. 3, in the preferred embodiment, diameter 18 is dimensioned according to the diameter 532 of the first cylindrical acceptor surface 531. Preferably, the diameter 18 of the first sealing surface 52 is smaller than the diameter 532 of the first cylindrical acceptor surface 531. As shown in FIG. 3, the diameter 18 of the preferred embodiment elastically expands to accommodate the diameter 532 of the first cylindrical acceptor surface 531.

As shown in FIG. 10, adjacent to the first sealing surface 52 is a second sealing surface 56 and a third sealing surface 57. Referring now to FIG. 3, in the preferred embodiment, the second sealing surface 56 and the third sealing surface 57 are shaped to fit within a notch, or preferably, a seal acceptor 530. As shown in FIG. 30, in an alternative embodiment, the second and third sealing surfaces 56, 57 are shaped to fit within a seal acceptor 710 on a second end 705 of a coupling member 700. In yet another alternative embodiment, as shown in FIG. 16, the second sealing surface 56 and the third sealing surface 57 are shaped to fit within a seal acceptor 530 and a first end 704 of a coupling member 700. As shown therein, the second and third sealing surfaces 56, 57 cooperate with the seal acceptor 530 and the coupling member 700 to provide a lubricant-tight seal.

As depicted in FIG. 1, the seal 10 is provided with an outer surface 65. The outer surface 65 is configured to cooperate with the inner surface 19. By way of example and not limitation, FIG. 9 depicts the outer surface 65 configured so that the seal 10 flexes at predetermined flex areas.

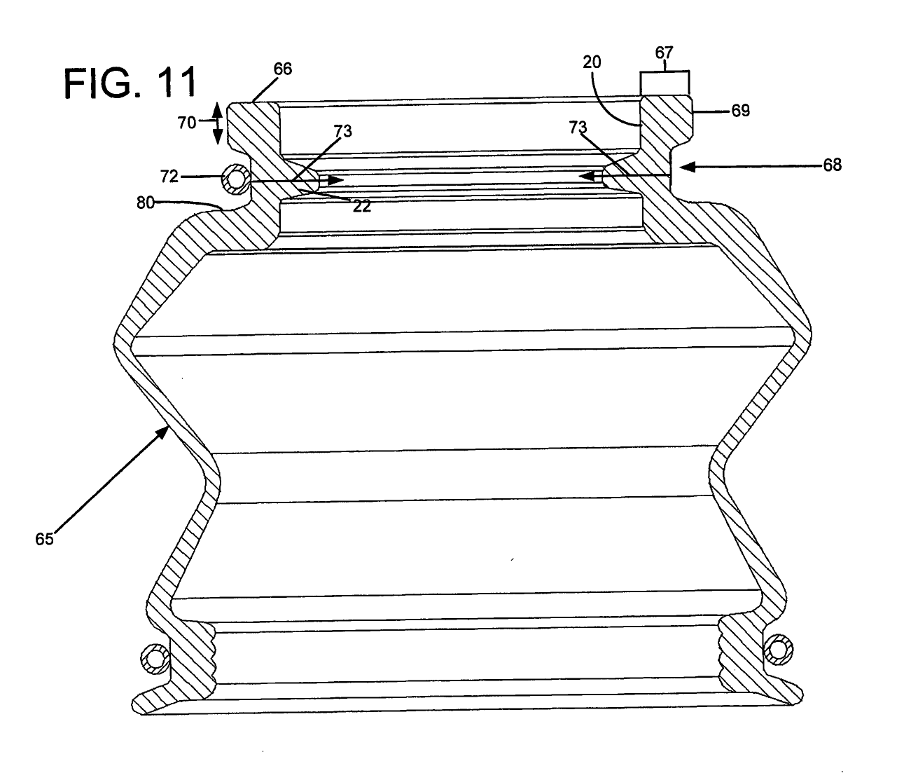

Referring now to FIG. 11, the outer surface 65 is provided with a first annular surface 66 located adjacent to the first interface surface 20. The first annular surface 66 has a width 67. The width 67 is dimensioned to cooperate with a shaft. More particularly, the width 67 is dimensioned to provide a predetermined amount of elasticity.

Located adjacent to the first annular surface 66 is a first outer cylindrical surface 69. As shown in FIG. 11, the first outer cylindrical surface 69 has a length 70 that provides the seal 10 with sufficient rigidity so that a first constricting element 72 is retained on the seal 10.

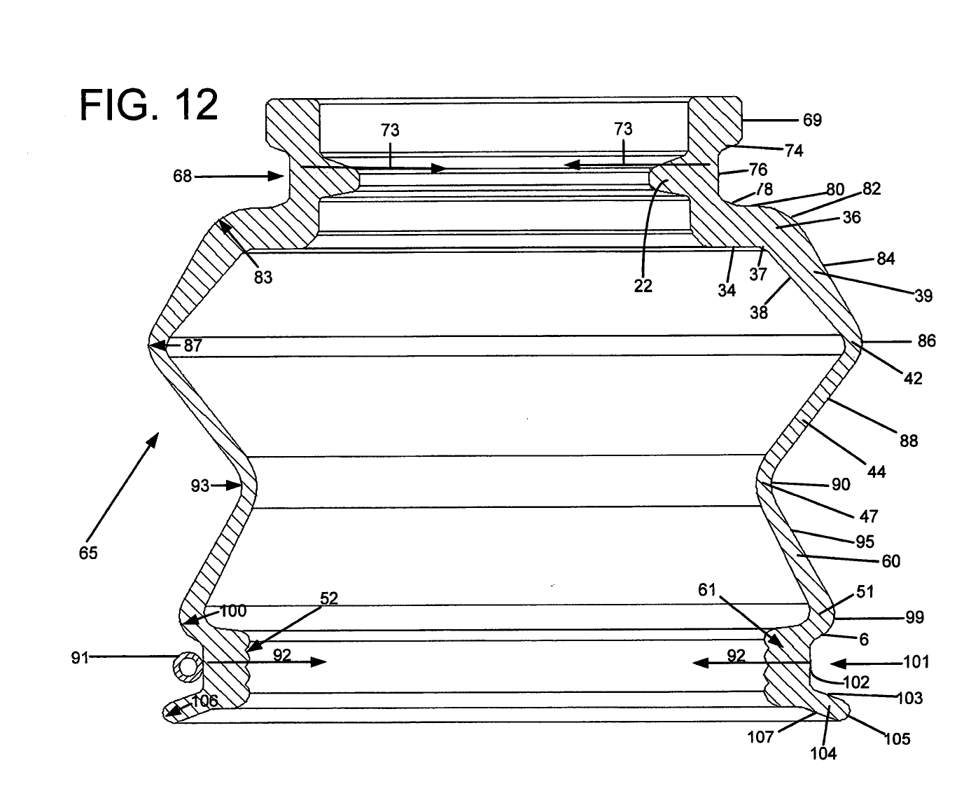

Referring again to FIG. 11, located adjacent to the first outer cylindrical surface 69 is a first retaining surface 68. The first retaining surface 68 is configured to cooperate with the first constricting element 72. According to one aspect of the present invention, the first retaining surface 68 is shaped to retain the first constricting element 72. According to another aspect of the present invention, the first retaining surface 68 is shaped so that the first constricting element 72 exerts a force in the direction of arrow 73 (shown in FIG. 12). According to yet another aspect of the present invention, the first retaining surface 68 is shaped so that the first constricting element 72 exerts a force on the first securing member 22.

The first retaining surface 68 is provided with a plurality of surfaces. Referring now to FIG. 12, the first retaining surface 68 of the preferred embodiment is provided with a first outer frusto-conical surface 74 shaped so that the first constricting element 72 exerts a force in the direction of arrow 73 (shown in FIG. 12), preferably a predetermined force on the first securing member 22. The first outer frusto-conical surface 74 is angled. As shown in FIG. 5, the first outer frusto-conical surface 74 is at an angle 75 with respect to imaginary line A, which runs perpendicular to the axis Ax of the seal 10. In the preferred embodiment, the angle 75 is 20°.

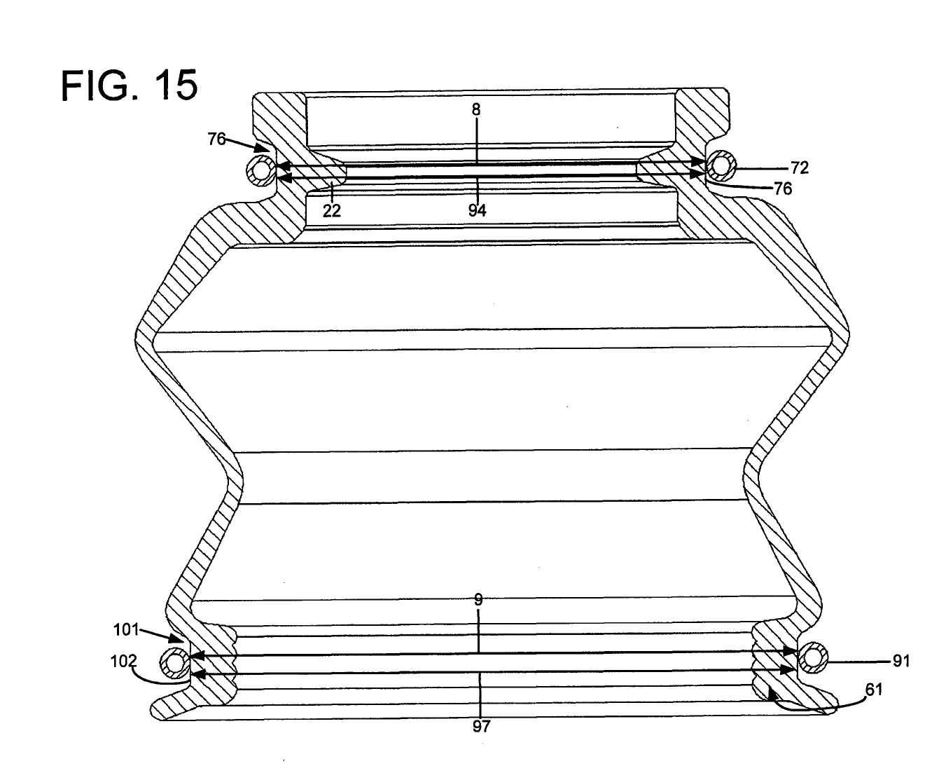

The first outer frusto-conical surface 74 is adjacent to a second outer cylindrical surface 76. The second outer cylindrical surface 76, located within the first retaining surface 68, is provided with a diameter 94. As shown in FIG. 15, the diameter 94 is dimensioned according to the diameter 8 of the first constricting element 72. Preferably, the second outer cylindrical surface 76 is provided with a diameter such that the first constricting element 72 exerts a force on the first securing member 22. The force is related to the spring constant of the first constricting element 72.

As shown in FIG. 12, adjacent to the second outer cylindrical surface 76 is a second outer frusto-conical surface 78 shaped so that the first constricting element exerts a force in the direction of arrow 73 (shown in FIG. 12), preferably a predetermined force on the first securing member 22. As shown in FIG. 5, the second outer frusto-conical surface 78 is at an angle 79 with respect to imaginary line B, which runs perpendicular to the axis Ax of the seal 10. In the preferred embodiment, the angle 79 is 20°.

As shown in FIG. 6, the presently preferred embodiment is provided with an outer corresponding surface 80 shaped so that the first constricting element 72 is positioned with greater accuracy, such as when the first constricting element 72 is positioned via an automated process. As depicted in FIG. 6, the outer corresponding surface 80 is in a plane generally parallel to the inner corresponding surface 34, so that, after fabrication, the seal 10 shrinks uniformly during cooling. In the preferred embodiment, the outer corresponding surface 80 is generally annular, extending a radial distance 81 that corresponds to the radial distance 35 of the inner corresponding surface 34.

Referring now to FIG. 12, the seal 10 is provided with a second retaining surface 101. The second retaining surface 101 is configured to cooperate with a second constricting element 91. According to one aspect of the present invention, the second retaining surface 101 is shaped to retain the second constricting element 91. According to another aspect of the present invention, the second retaining surface 101 is shaped so that the second constricting element 91 exerts a force in the direction of arrow 92. According to yet another aspect of the present invention, the second retaining surface 91 is shaped so that the second constricting element 91 exerts a force on the second securing member 61.

The second retaining surface 101 is provided with a plurality of surfaces. Referring again to FIG. 12, the second retaining surface 101 is provided with the third outer frusto-conical surface 6. As shown in FIG. 5, the third outer frusto-conical surface 6 is at an angle 7 with respect to imaginary line F, which runs perpendicular to the axis Ax of the seal 10. In the preferred embodiment, the angle 7 is 23°.

The third outer frusto-conical surface 6 is shaped to retain the second constricting element 91 within the second retaining surface 101. The third outer frusto-conical surface 6 is also shaped so that the second constricting element 91 exerts a force in the direction of arrow 92 (shown in FIG. 12), preferably a predetermined force on the second securing member 61. Furthermore, the third outer frusto-conical surface 6 is shaped so that the second constricting element 91 is positioned with greater accuracy, such as when the second constricting element 91 is positioned via an automated process.

The third outer frusto-conical surface 6 is adjacent to a third outer cylindrical surface 102. The third outer cylindrical surface 102 is provided with a diameter 97. As shown in FIG. 15, the diameter 97 is dimensioned according to the diameter 9 of the second constricting element 91. The third outer cylindrical surface 102, located within the second retaining surface 91, is provided with a diameter 97 dimensioned such that the second constricting element 91 exerts a force on the second securing member 61. Preferably, the force is related to the spring constant of the second constricting element 91.

Adjacent to the third outer cylindrical surface 102 is a fourth outer frusto-conical surface 103. As shown in FIG. 5, the fourth outer frusto-conical surface 103 is at an angle 62 with respect to imaginary line F, which runs perpendicular to the axis Ax of the seal 10. In the preferred embodiment, the angle 62 is 20°.

The fourth outer frusto-conical surface 103 is shaped to retain the second constricting element 91 within the second retaining surface 101. The fourth outer frusto-conical surface 103 is also shaped so that the second constricting element 91 exerts a force in the direction of arrow 92 (shown in FIG. 12), preferably a predetermined force on the second securing member 61. Furthermore, the fourth outer frusto-conical surface 103 is shaped so that the second constricting element 91 is positioned with greater accuracy, such as when the second constricting element 91 is positioned via an automated process.

Referring again to FIG. 12, the fourth outer frusto-conical surface 103 is located on an installation member 104, which, as shown in FIG. 3, is shaped to cooperate with a socket 520. The second installation member 104 is configured to provide greater ease in installing the seal 10 through the action of an installation surface 107 (shown in FIG. 12) configured to expand the diameter 97 (shown in FIG. 15) of the second securing member 61. As shown in FIG. 5 the installation surface 107 is at an angle 108 with respect to imaginary line G, which runs perpendicular to the axis Ax of the seal 10. In the preferred embodiment, the angle 108 is 13°.

The second installation member 104 of the presently preferred embodiment is provided with a plurality of surfaces. As shown in FIG. 12, the second installation member 104 is provided with an outer convex surface 105. The outer convex surface 105 has a cross-sectional shape of an arc of an imaginary circle. As shown in FIG. 12, the imaginary circle is provided with a radius 106 preferably measuring 0.50 cm. While the presently preferred embodiment is shown with a second installation member 104 that provides greater ease in installing the seal 10, in an alternative embodiment, the seal 10 is fabricated without the second installation member 104.

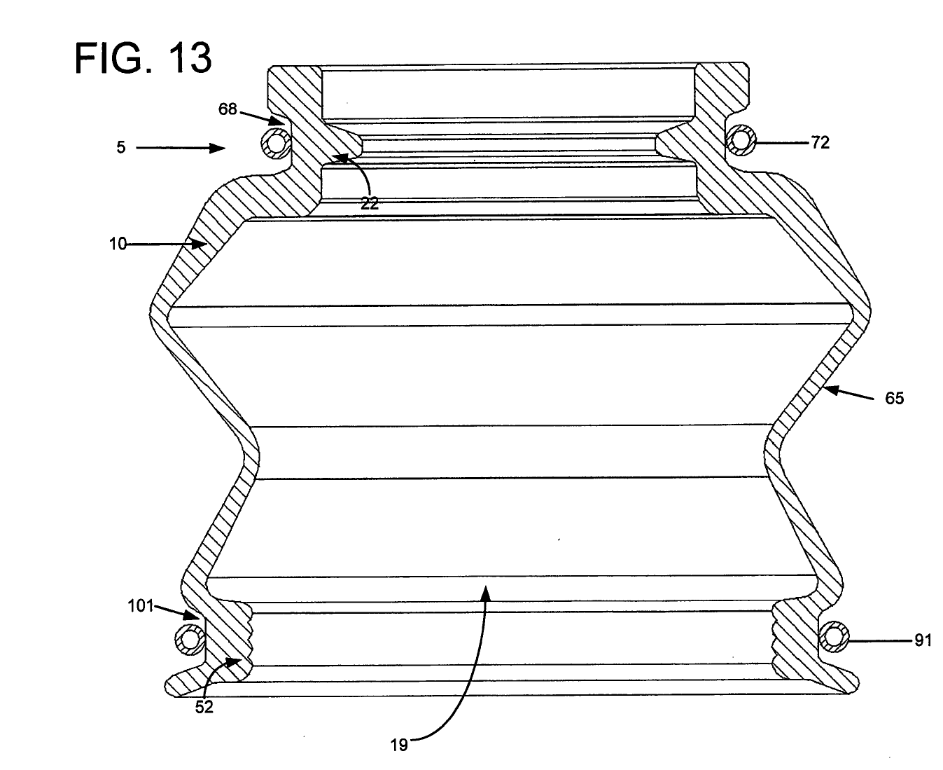

In FIG. 13, the seal 10 of the preferred embodiment is depicted with a first constricting element 72 and a second constricting element 91. According to one aspect of the present invention, the constricting elements 72, 91 are configured to cooperate with the seal 10. According to another aspect, the constricting elements 72, 91 are configured to cooperate with the outer surface 65. According to yet another aspect of the present invention, the constricting elements 72, 91 are configured to cooperate with the inner surface 19.

FIG. 13 depicts the constricting elements 72, 91 cooperating with the seal 10. As shown therein, the first constricting element 72 is held in place by the first retaining surface 68 located on the outer surface 65 of the seal 10. FIG. 13 also depicts the second constricting element 91 held in place by the second retaining surface 101 located on the outer surface 65 of the seal 10. The first and second retaining surfaces 65, 91 are shaped so that the constricting elements 72, 91 exert a force upon the securing element 22 and the sealing portion 52, respectively.

Turning now to FIG. 3, in the preferred embodiment, the constricting elements 72, 91 exert a force upon the seal 10 in a radially inward direction. As shown therein, in the preferred embodiment, the first constricting element 72 exerts a force upon the securing element 22 such that the securing element 22 is located within the seal acceptor 115. Also shown therein, in the preferred embodiment, the second constricting element 91 exerts a force upon the sealing portion 52 such that the sealing portion 52 is located within a seal acceptor 530 on the socket 520. In the preferred embodiment, the first and second constricting elements 72, 91 exert forces according to the spring constants of the constricting elements 72, 91.

The constricting elements 72, 91 are fabricated from a plurality of materials. According to one aspect of the present invention the first constricting element 72 is fabricated from a material including a metal, such as steel.

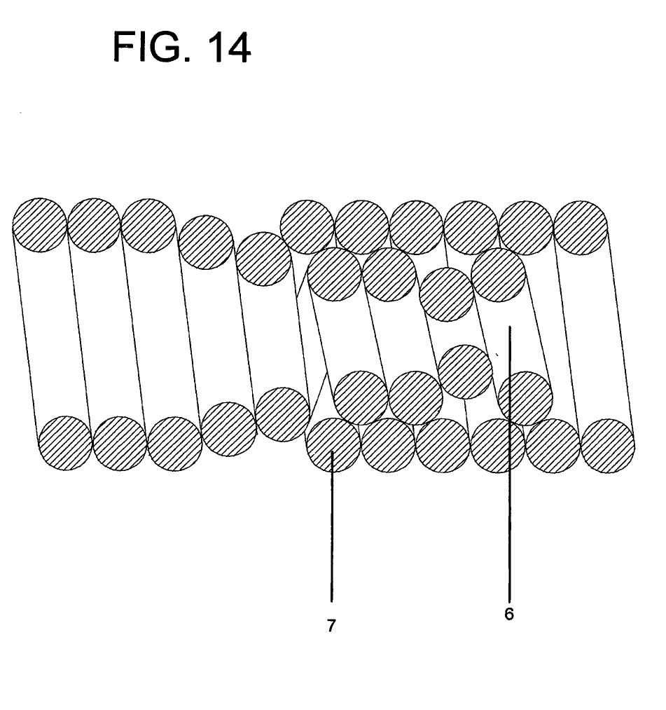

Each of the constricting elements 72, 91 is in the shape of a spring and provided with a first coil end 6 and a second coil end 7. As shown in FIG. 14, the first coil end 6 is inserted within the second coil end 7 and retained therein through an interference fit.

Referring now to FIG. 15, the first constricting element 72 is provided with a diameter 8. The diameter 8 is dimensioned according to the diameter 94 of the second outer cylindrical surface 76. The diameter 8 is preferably smaller than the diameter 94 of the second outer cylindrical surface 76. The second constricting element 91 is provided with a diameter 9 that is dimensioned according to the diameter 97 of the third outer cylindrical surface 102. The diameter 9 is preferably smaller than the diameter 97 of the third outer cylindrical surface 102. Each of the constricting elements 72, 91 resiliently expands during installation so that each constricting element exerts a force on the seal 10 according to the spring constant of the constricting member 71, 91.

Turning now to FIG. 3, the seal 10 constituting the presently preferred embodiment is depicted. As shown therein, the seal 10 is configured to cooperate with a joint, which in the preferred embodiment is a ball joint 109. As shown in FIG. 3, the seal 10 cooperates with a ball joint 109 that is provided with a socket 520.

As shown in FIG. 3, the socket 520 is provided with a ball cooperating surface 521. The ball cooperating surface 521 is configured to cooperate with the ball stud 110. According to one aspect of the present invention, the ball cooperating surface 521 is dimensioned so that the at least a portion of the ball stud 110 fits within the ball cooperating surface 521. According to another aspect of the present invention, the ball cooperating surface 521 is shaped so that the ball stud 110 is able to pivot therein.

The socket 520 is provided with a socket outer surface 522. According to one aspect, the socket outer surface 522 is configured to cooperate with the seal. According to another aspect, the socket outer surface 522 is configured to cooperate with a seal guard 600. According to yet another aspect, the socket outer surface 522 is configured to be coupled to another body.

The socket outer surface 522 is configured to be coupled to another body. According to one aspect, the socket outer surface 522 is configured to be coupled to a coupling member 700. According to another aspect, the socket outer surface 522 is configured to be coupled to the seal guard 600.

FIGS. 3 and 16 depict the socket outer surface 522 provided with a groove 523. The groove 523 is shaped to couple a coupling member 700 to the socket 520. As depicted in FIG. 16, the coupling member 700 is coupled to the socket 520 through crimping. This crimping is accomplished via a first end 704 provided on the coupling member 700.

The coupling member 700 is composed of a metal, advantageously a steel. Alternatively, the coupling member 700 is composed of a composite material. As shown in FIG. 16, the coupling member 700 is provided with a first end 704 dimensioned according to the socket 520. According to one aspect, the first end 704 is configured to cooperate with the socket outer surface 522. According to another aspect, the first end 704 is configured to cooperate with the seal 10. According to yet another aspect, the first end 704 is configured to cooperate with a seal guard 600.

FIG. 16 depicts the first end 704 as circular in shape, having a diameter 717 dimensioned according to a diameter 524 of the socket 520. Also depicted, the first end 704 provided with the retaining portion 708 that is configured to retain the socket 520. As shown in FIG. 16, the retaining portion 708 is crimped over a portion of the socket outer surface 522. In the preferred embodiment, the retaining portion 708 is crimped over the groove 523 of the socket 520.

As shown in FIGS. 3 and 16, the socket 520 is provided with a seal acceptor 530 that is configured to cooperate with the seal 10. According to one aspect of the present invention, the seal acceptor 530 is dimensioned so that a portion of the seal 10 fits within the seal acceptor 530. According to another aspect, the seal acceptor 530 is configured to cooperate with the coupling member 700.

In FIG. 3, the seal acceptor 530 is shown with a portion of the seal 10 fitted within. As shown therein, the seal acceptor 530 is dimensioned according to the second securing member 61. Referring now to FIG. 16, the seal acceptor 530 is dimensioned according to the first end 704 of the coupling member 700. The seal acceptor 530 of the preferred embodiment is provided with a cylindrical acceptor surface 531. As shown in FIG. 3, the cylindrical acceptor surface 531 has a diameter 532 that is dimensioned according to the diameter 18 of the first sealing surface 52. Preferably diameter 532 is larger than the diameter 18 of the first sealing surface 52. While FIGS. 3 and 16 depict a cylindrical shaped seal acceptor 530, in an alternative embodiment, the seal acceptor 530 is conical or frusto-conical in shape.

The seal acceptor 530 is configured to cooperate with the second securing member 61. FIG. 3 depicts the seal acceptor 530 accommodating the first sealing surface 52, the second sealing surface 56, and the third sealing surface 57. Advantageously, the seal acceptor 530 is configured so that the second securing member 61 fits within so as to seal a lubricant within the seal 10. The preferred embodiment accomplishes this through the sealing surfaces 52, 56, 57 and the fourth inner curved surface 50 (shown in FIG. 3) providing a lubricant-tight seal.

In the embodiment depicted in FIG. 16, the seal acceptor 530 is configured to cooperate with the second securing member 61 and the coupling member 700. As shown in FIG. 16, the second securing member 61 fits within a volume defined by the seal acceptor 530 and the coupling member 700 to provide a lubricant-tight seal.

Turning now to FIGS. 3 and 16, the ball joint 109 is provided a ball stud 110. The ball stud 110 is provided with a ball portion 111 that is configured to cooperate with the socket 520. According to one aspect of the present invention, the ball portion 111 is configured to fit within a portion of the socket 520. According to another aspect of the present invention the ball portion 111 is configured to pivot within a portion of the socket 520.

FIGS. 3 and 16 depict the ball portion 111 within a portion of the socket 520. As shown in FIG. 9, the ball portion 111 is within a ball cooperating surface 521 and is able to pivot within the socket 520. As shown, the ball portion 111 is provided with at least a partially spherical shape.

As shown in FIG. 17, the ball stud 110 is provided with a shaft 116 having a cylindrical shaft portion 117. Advantageously, the cylindrical shaft portion 117 is connectable to a suspension arm/torsion bar.

The shaft 116 is preferably provided with a torque transmitter 121. The torque transmitter 121 is configured to transmit torque. The preferred embodiment is show in FIG. 17 with a torque transmitter 121 that is in the shape of a polygon, preferably a hexagon; however, other configurations that transmit torque are within scope of this invention. As depicted in FIG. 4, the torque transmitter 121 is located within the shaft 116 in the form of an internal drive, preferably as a six point internal drive. However, other internal drives may be used without departing from the scope of the present invention.

The shaft 116 is provided with a seal cooperating surface 112 configured to cooperate with the seal 10. As shown in FIGS. 3 and 16, the seal cooperating surface 112 is shaped according to at least a portion of the first securing member 22. FIG. 17 depicts the seal cooperating surface 112 of the preferred embodiment provided with a first cylindrical surface 113 having a diameter 114. The diameter 114 is related to a diameter 21 (shown in FIG. 3) of the first interface surface 20. Preferably, the diameter 114 is larger than the diameter 21 of the first interface surface 20.

As shown in FIG. 17, located within the seal cooperating surface 112 is a seal acceptor 115. The seal acceptor 115 is configured to cooperate with the seal 10. According to one aspect of the present invention, the seal acceptor 115 is dimensioned so that a portion of the seal 10 is fit within the seal acceptor 115.

As shown in FIGS. 3 and 16, the first securing member 22 of the seal 10 preferably fits within the seal acceptor 115. As depicted therein, the seal acceptor 115 is shaped to accommodate the first securing member 22. Advantageously, the first securing member 22 fits within the seal acceptor 15 so that a lubricant is retained with the seal 10. As shown in FIG. 17, the seal acceptor 115 is a surface having a diameter 118 that is smaller than the diameter 114 of the seal cooperating surface 112.

As shown in FIG. 17, the seal cooperating surface 112 of the preferred embodiment is provided with a second cylindrical surface 119 having a diameter 120. The diameter 120 is related to a diameter 14 of the second interface surface 13. Preferably, the diameter 120 is larger than the diameter 14 of the second interface surface 13.

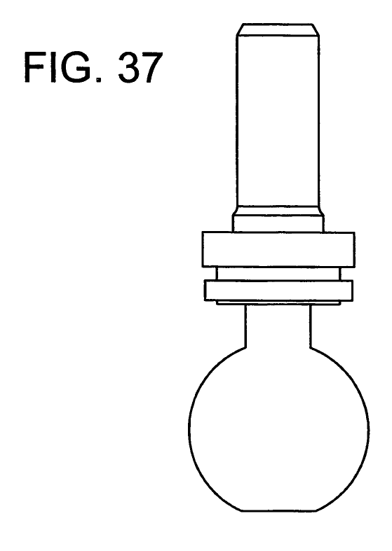

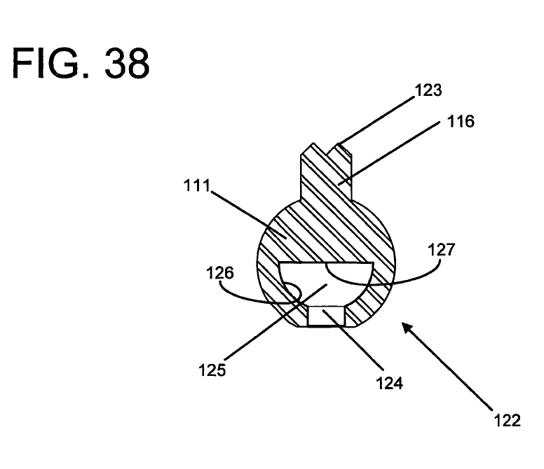

FIG. 37 depicts a ball stud 110 of an alternative embodiment. The ball stud 110 shown in FIG. 37 is fabricated from a plurality of stud elements. The first stud element 122 is depicted in FIG. 38. As depicted therein, the first stud element 122 includes the ball portion 111 and a portion of the shaft 116.

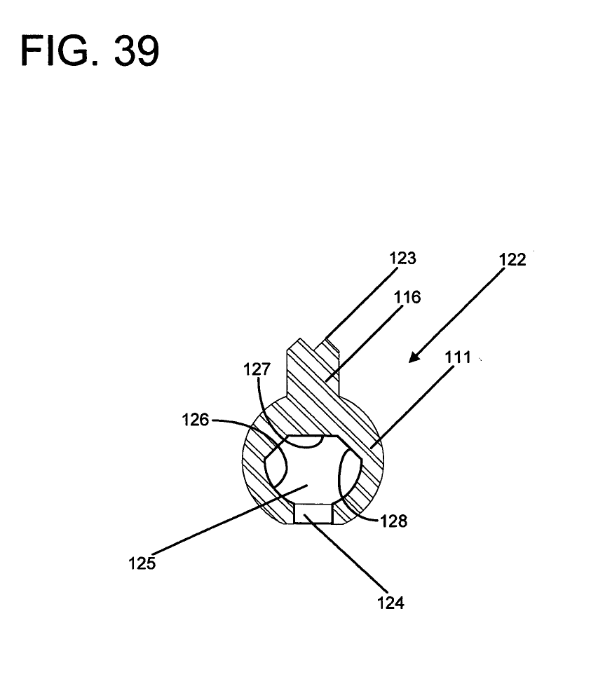

Referring now to FIG. 38, the ball portion 111 defines an opening 124 and is provided with a plurality of inner ball surfaces that define a cavity 125. In the embodiment depicted in FIG. 38, the ball portion 111 is provided with an inner curved surface 125. Located adjacent to the inner curved surface 125 is an inner flat surface 126. Alternatively, as depicted in FIG. 39, an inner conical surface 127 is located adjacent to the inner curved surface 125. The inner conical surface 127 is at an angle, preferably between 0 and 90 degrees relative to the inner flat surface 126 located adjacent to the inner conical surface 127.

The first stud element 122 is fabricated through forging. As used herein, the term “forge,” “forging,” or “forged” is intended to encompass what is known in the art as “cold forming,” “cold heading,” “deep drawing,” and “hot forging.” The first stud element 122 is forged with the use of a National® 750 parts former machine. However, other part formers, such as, for example, a Waterbury machine can be used. The process of forging the first stud element 122 begins with a metal wire or metal rod being drawn to size. The ends of the wire or rod are squared off by a punch. After being drawn to size, the wire or rod is run through a series of dies or extrusions. The cavity 125 shown in FIG. 38 and 39 is extruded through use of a punch and a pin.

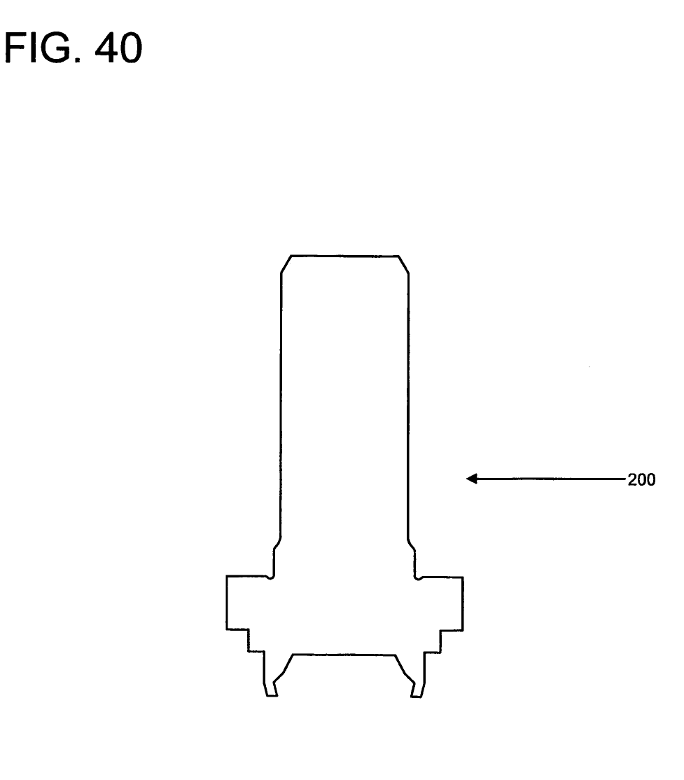

The first stud element 122 is configured for welding. As shown in both FIG. 38 and 39, the first stud element 122 is provided with a plurality of projections 123. These projections 123 are shaped for welding. The projections 123 shown in FIG. 40 are at an angle of between 35 and 60 degrees relative to the axis of the first stud element (shown as imaginary line F. In the embodiment depicted in FIG. 40, the projections 123 are dimensioned to include a predetermined volume; preferably, the projections 123 include a predetermined volume of welding material.

The first stud element 122 is connected to a second stud element 200 through welding, preferably resistance welding. The projections 123 contact the second stud element 200. High pressure is applied to the area where the projections 123 contact the second stud element 200. After contact, the projections 123 are configured to pass a high current to the through the second stud element 200. Advantageously, the projections 123 are configured to melt and weld together the first stud element 122 and the second stud element 200.

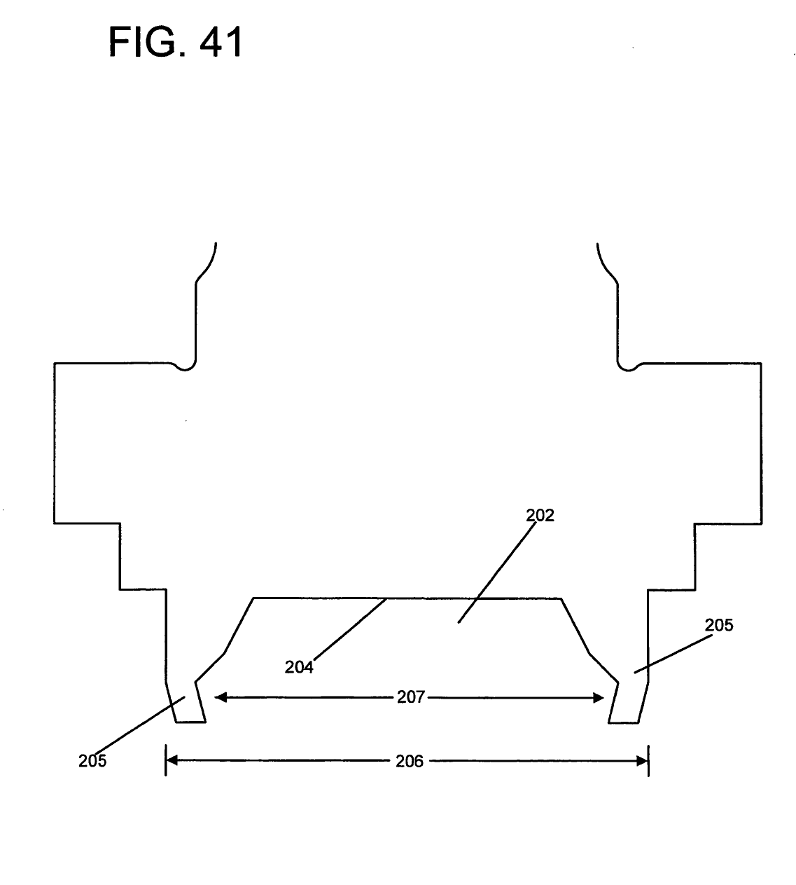

The second stud element 200 is configured to accept the first stud element 122. As depicted in FIG. 41, the second stud element 200 is provided with a coupling surface 201. According to one aspect, the coupling surface 201 is shaped to connect the second stud element 200 to the first stud element 122. According to another aspect, the coupling surface 201 is shaped to connect the second stud element 200 to a third stud element 300.

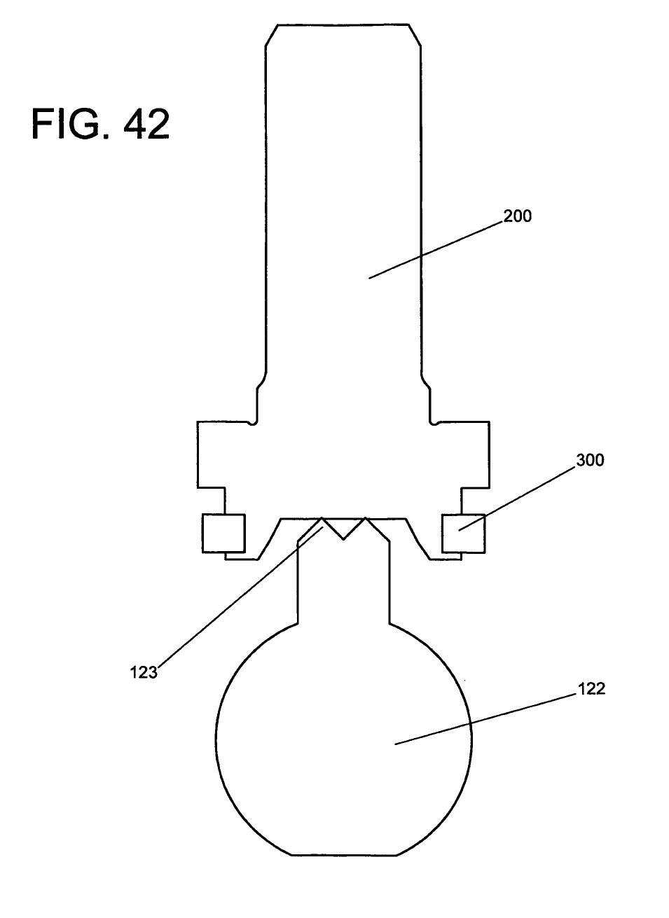

Referring now to FIG. 42, the coupling surface 201 is provided with a plurality of surfaces that define a volume 202. The coupling surface 201 includes a side surface 203 that is conically shaped; however, in an alternative embodiment, the side surface 203 is cylindrically shaped. Located adjacent to the side surface 203 is a flat surface 204. While the preferred embodiment is depicted as having a flat surface 204, in an alternative embodiment, the surface 204 is curved or angled.

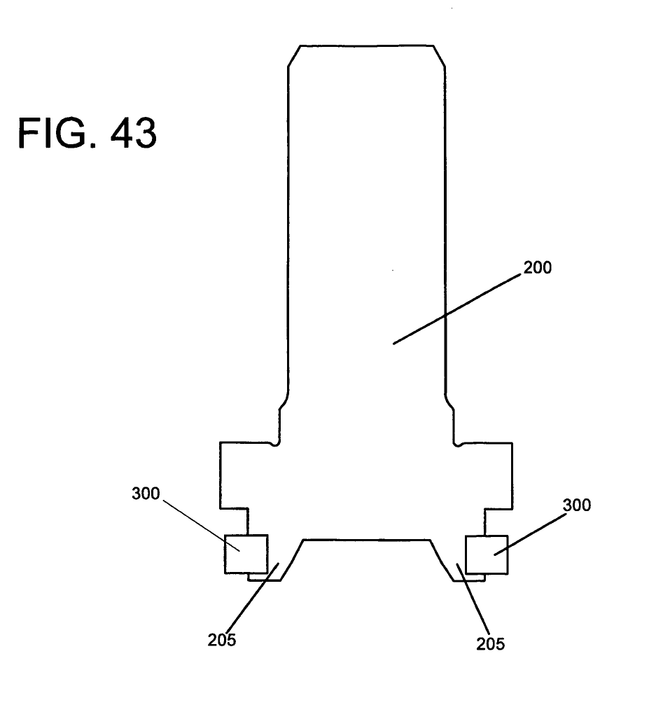

The volume 202 defined by the coupling surface 201 is determined according to the volume of material included in the projections 123 on the first stud element 122. FIG. 43 depicts the second stud element 200 being welded to the first stud element 122. As shown therein, the coupling surface 201 is dimensioned according to the first stud element 122; in the embodiment shown in FIG. 43, the coupling surface 201 is dimensioned to accommodate the projections 123 on the first stud element 122. As depicted, after the projections 123 melt, the volume of material included therein is accommodated within the volume defined by the coupling surface 201.

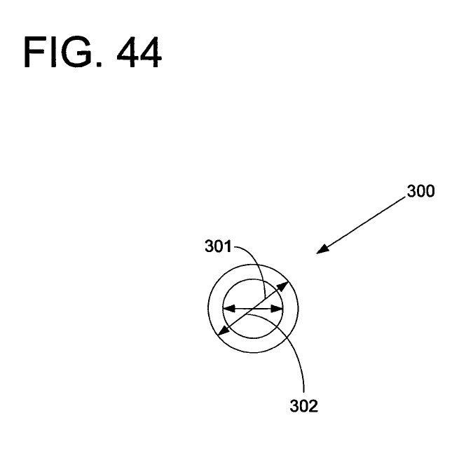

Located adjacent to the coupling surface 201 is a connecting member 205. The connecting member 205 is configured to cooperate with a third stud element 300. Referring now to FIG. 42, the connecting member 205 is shown located adjacent to the coupling surface 201. The connecting member 205 is shaped for ease in positioning the third stud element 300 on the second stud element 300. In FIG. 44, the connecting member 205 is at an angle so that it retains the third stud element 300. Preferably, the connecting member 205 is crimped around at least a portion of the third stud element 300 so that the third stud element 300 is connected to the second stud element 200.

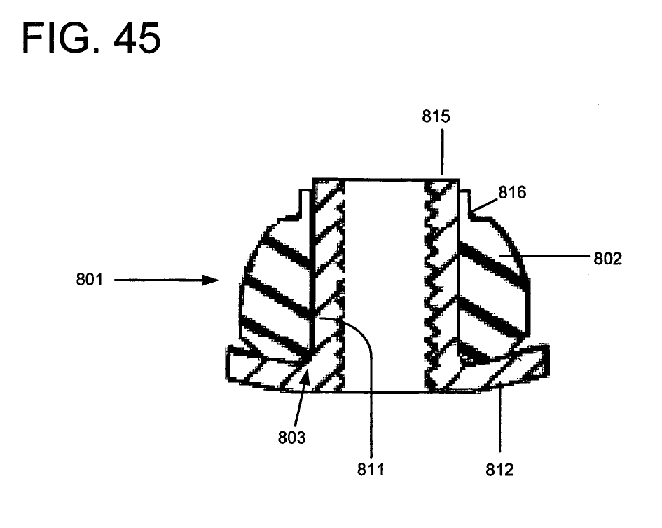

Referring again to FIG. 42, the connecting member 205 is provided with a major diameter 206 and a minor diameter 207. The major and minor diameters 206, 207 are dimensioned so that the connecting member has sufficient strength to be crimped. The major diameter 206 is dimensioned according to the third stud element 300. Preferably, the major diameter 206 of the connecting member 205 is dimensioned according to a minor diameter 301 of the third stud element 300, as shown in FIG. 45.

The third stud element 300 is shown in FIG. 45. According to one aspect, the third stud element 300 is shaped to cooperate with the seal 10. According to another aspect, the third stud element is shaped to cooperate with the second stud element 200. In FIG. 45, the third stud element 300 is annular in shape with a major diameter 302 and a minor diameter 301. The minor diameter 301 is dimensioned according to the second stud element 200. Preferably, the minor diameter 301 is dimensioned so that the connecting member 205 of the second stud element 200 fits within the third stud element 300. The major diameter 302 of the third stud element 300 is dimensioned so that a seal cooperating surface 112 is provided on the ball stud 110.

In an alternative embodiment a seal guard 600 is provided. FIG. 16 depicts a seal guard 600 shaped to protect the seal 10. In the embodiment depicted in FIG. 16, the seal guard 600 is configured to protect the seal 10 from the socket 520. In the embodiment depicted in FIG. 16, the seal guard 600 is shaped according to the socket 520. As further depicted in FIG. 16, the seal guard 600 is cup-shaped and dimensioned to be fit around the socket 520.

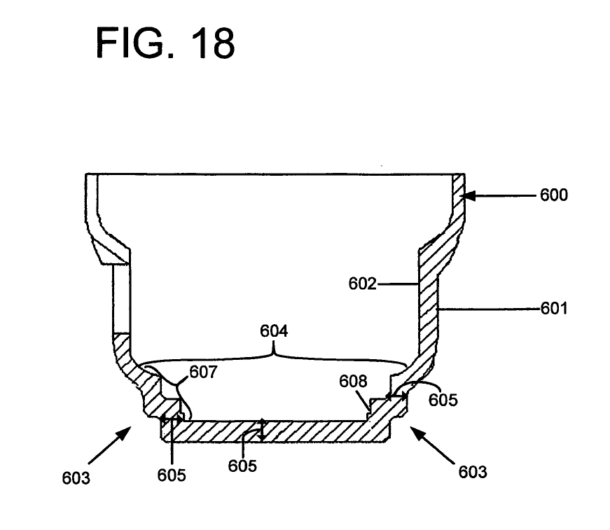

Turning now to FIG. 18, the seal guard 600 is provided with an outer guard surface 601 and an inner guard surface 602. According to one aspect of the present invention, the outer guard surface 601 is configured to protect the seal 10. According to another aspect of the present invention, the outer guard surface 601 is configured to strengthen the seal guard 600. According to yet another aspect of the present invention, the outer guard surface 601 is configured to cooperate with another assembly, such as another ball joint.

FIG. 18 depicts the outer guard surface 601. As shown therein, the outer guard surface 601 is provided with a guard corresponding surface 603. The guard corresponding surface 603 is shaped according to a socket interface surface 604 located within the inner guard surface 602. FIG. 18 depicts a cross-sectional view of the seal guard 600 and shows the guard corresponding surface 603 shaped according to the socket interface surface 604 so that the seal guard 600 has walls 605 of a uniform thickness.

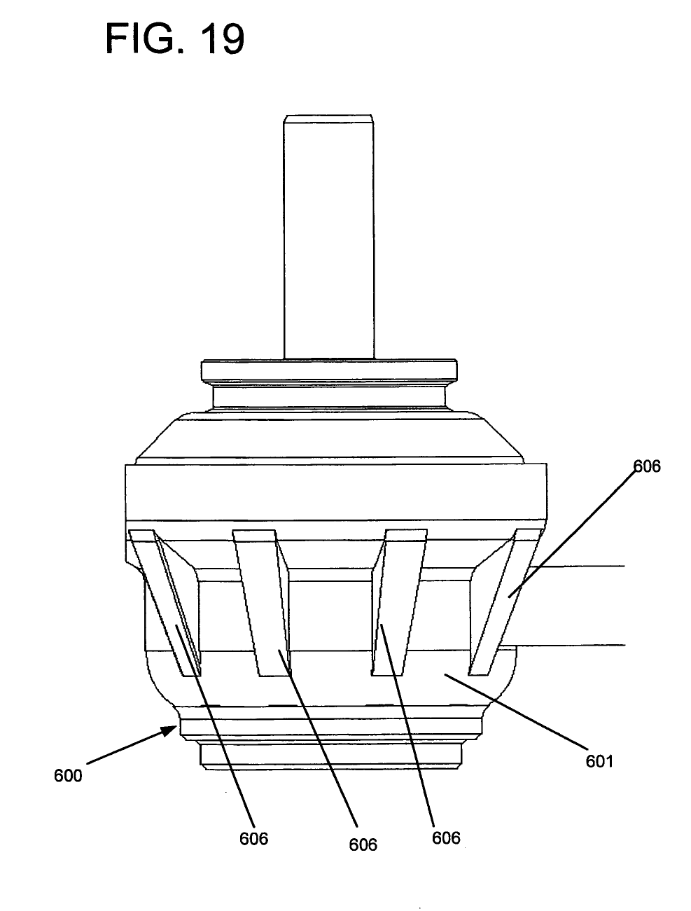

The outer guard surface 601 is provided with a plurality of ribs 606. The ribs 606 are configured to strengthen the seal guard 600. As shown in FIG. 19, the ribs 606 reinforce the walls 605 (shown in FIG. 18) so that the shape of the inner guard surface 602 is maintained.

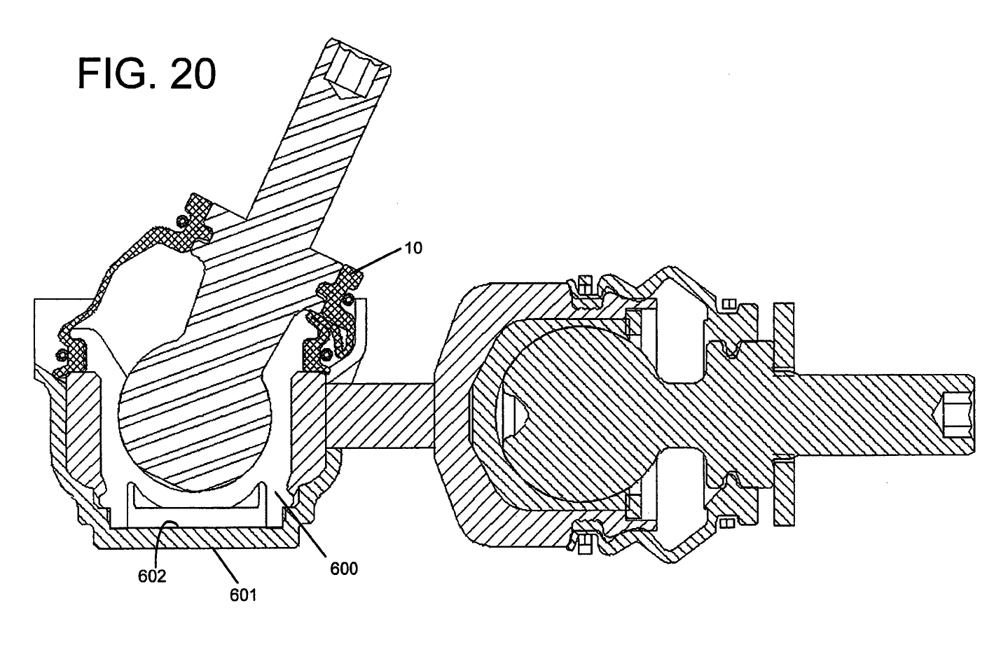

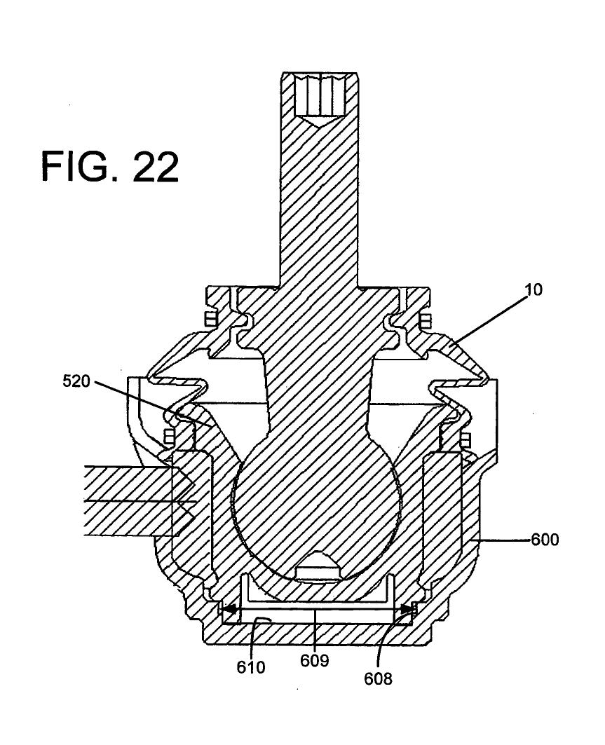

Referring to FIG. 22, the seal guard 600 is provided with an inner guard surface 602. The inner guard surface 602 is dimensioned according to the seal 10. As shown in FIG. 20, the inner guard surface 602 is configured to accommodate the seal 10 when a portion of the seal 10 is compressed.

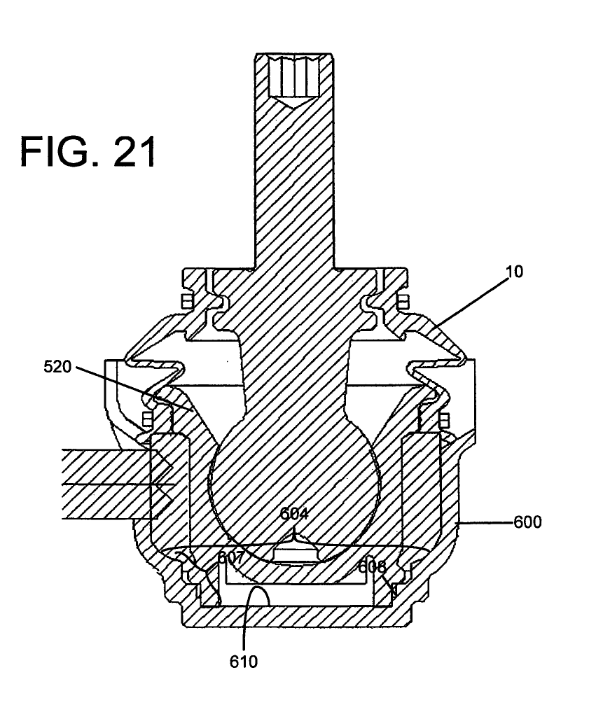

FIG. 21 depicts the seal guard 600 attached to the socket 520. As depicted, the socket interface surface 604 is shaped to cooperate with the socket 520. The socket interface surface 604 is shown with a positioning guide 607. The positioning guide 607 in FIG. 21 is provided with a step 608 that is shaped according to the socket outer surface 522. As shown in FIG. 22, the step 608 is circular in shape and has a diameter 609 that is dimensioned according to a circumference of the socket 520. The positioning guide 607 of the socket inner surface 604 is shaped so that the seal guard 600 can be sonically welded to the socket 520. The seal guard 600 shown in FIG. 22 is also provided with a covering surface 610. The covering surface 610 is located adjacent to the positioning guide 607.

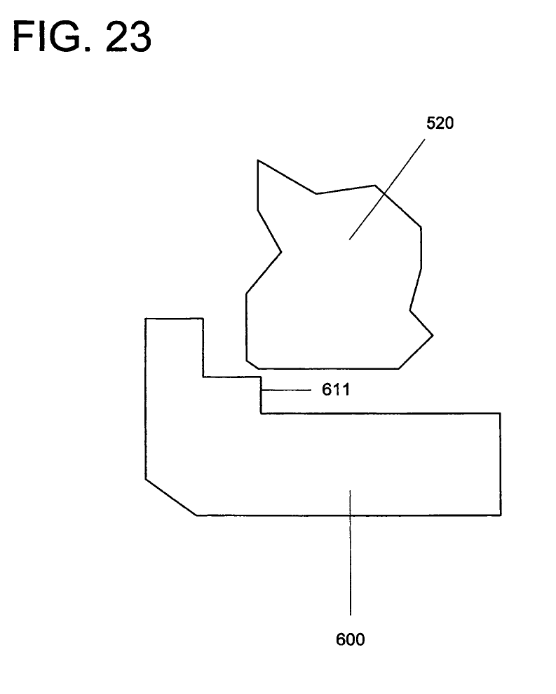

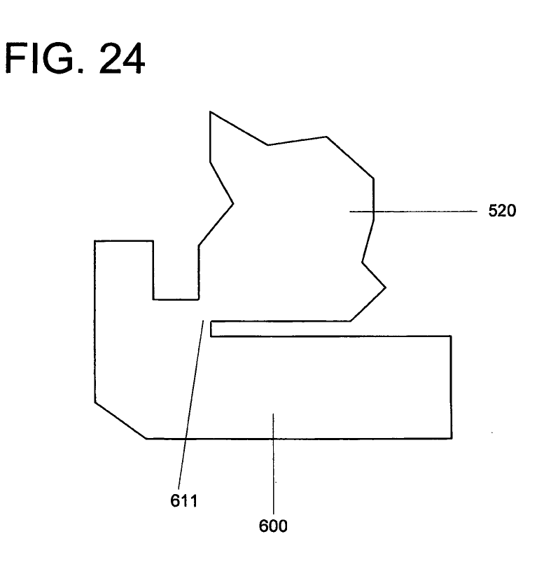

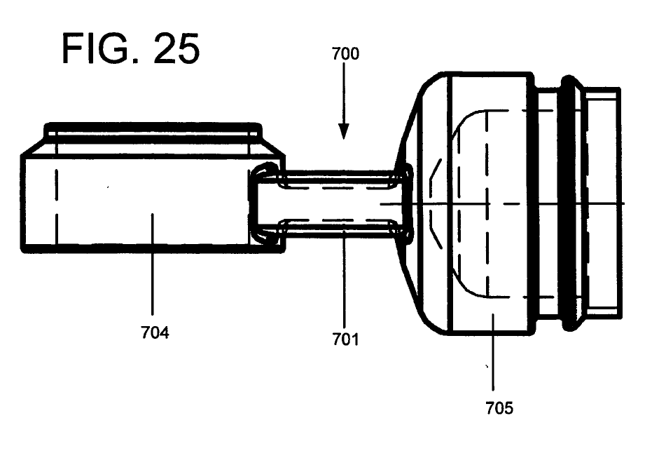

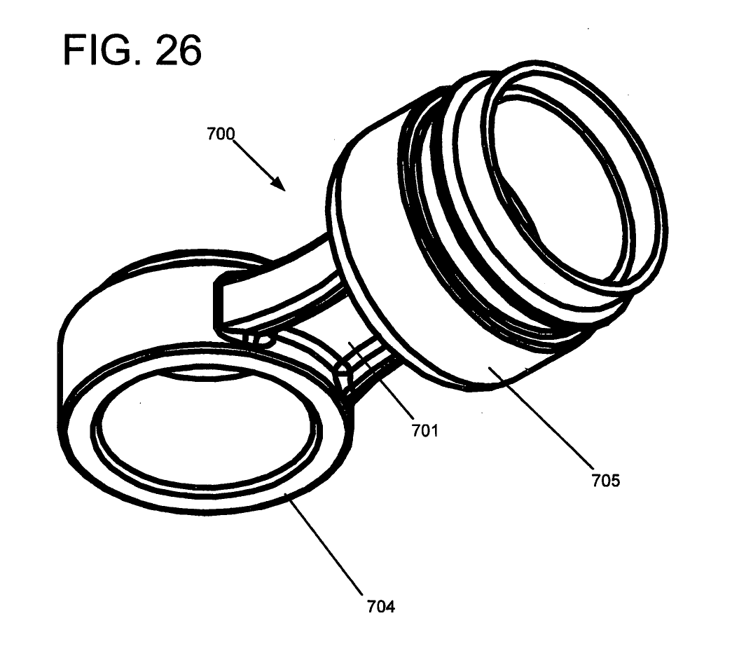

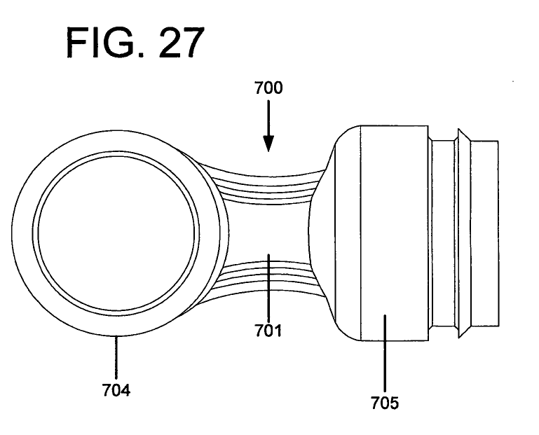

FIGS. 26 and 27 depict the seal guard 600 being sonically welded to the socket 520. As shown therein, the seal guard 600 is provided with a ridge 611. The ridge 611 is dimensioned to include sufficient material to bond the socket 520 to the seal guard 600. FIG. 23 depicts the socket 520 before welding, while FIG. 24 depicts the socket 520 after welding. As shown in FIGS. 25 and 26, the ridge 611 is configured to melt during welding so that the material flows along the inner guard surface 602 of the seal guard 600.

The embodiment shown in FIG. 16 is provided with a coupling member 700. In the preferred embodiment the coupling member 700 is fabricated from an alloy, preferably an aluminum alloy, such as an alloy including zinc and aluminum. In an alternative embodiment, the coupling member 700 is fabricated from steel. In yet another alternative the coupling member 700 is fabricated from a composite material. In such an alternative embodiment, the composite material includes carbon fibers oriented to provide strength.

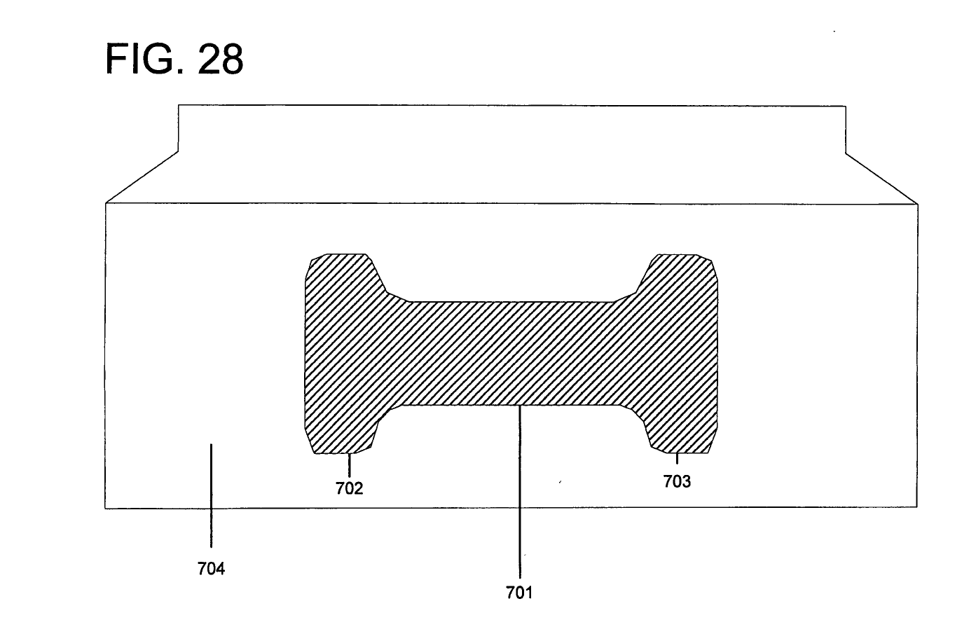

FIGS. 28, 29, and 30 show the coupling member 700 in greater detail. As shown, the coupling member 700 is provided with a stem 701, a first end 704, and a second end 705. In the embodiment shown therein, the first end 704 is provided with an annular shape and the second end 705 is provided with a cup shape.

Referring now to FIG. 28, the stem 701 includes two structural members 702, 703. FIG. 28, depicts a cross-sectional view of the stem 701, as shown therein, the stem 701 is shaped cross-sectionally as an I-beam.

In the presently preferred embodiment, the coupling member 700 is die cast as a unitary piece. In alternative embodiments, the annular shaped first end 704 and a cup shaped second end 705 are welded to the stem 701.

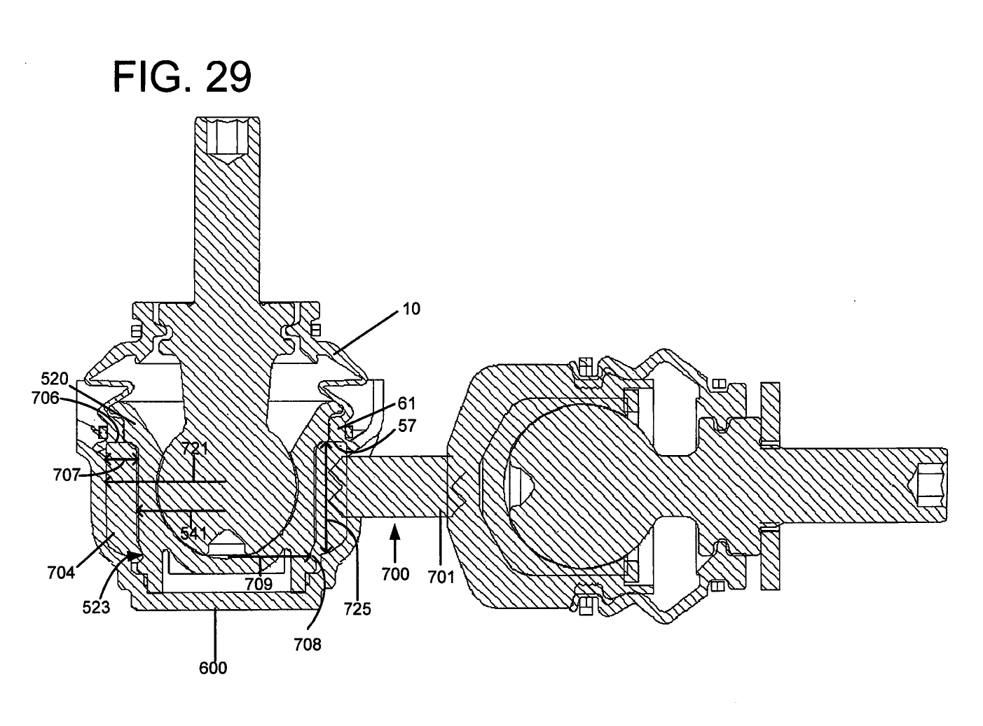

The coupling member 700 depicted in FIG. 29 is configured to cooperate with a socket 520. As shown in FIG. 29, the coupling member has a depth 725 dimensioned according to the socket 520. As shown in FIG. 29, the coupling member 700 is provided with a first end 704. The first end 704 is shaped according to the socket 520. In FIG. 29, the first end 704 is provided with an annular shape.

The first end 704 is provided with a radius 726 dimensioned according to a radius 541 of the socket 520. As shown in FIG. 29, the first end 704 includes an annulus 706 having a width 707. The width 707 is dimensioned according to the seal 10. FIG. 29 depicts the coupling member 700 and the seal 10 together. As shown therein, the width 707 is dimensioned to cooperate with the second securing member 61 to provide a lubricant tight seal. In the embodiment depicted in FIG. 29, the third sealing surface 57 of the seal 10 is in sealing contact with the annulus 706.

The coupling member 700 is provided with a retaining portion 708. As depicted in FIG. 29, the retaining portion 700 is located on the first end 704 and has a radius 709 dimensioned according to the socket 520. The retaining portion 708 is dimensioned to fit within a groove 523 defined by the socket 520. The retaining portion 708 is configured to couple the coupling member 700 to the socket 520 through crimping. The retaining portion 708 is crimped into the socket 520. FIG. 29 depicts the retaining portion crimped within the groove 523 of the socket 520.

The coupling member 700 is provided with a second end 705 in a plurality of configurations. According to one aspect, the second end 705 is configured to cooperate with a socket 534. According to another aspect, the second end is configured to cooperate with a grommet 802. According to yet another aspect, the second end 705 is configured to cooperate with a nut. According to still another aspect, the second end 705 is configured to cooperate with a sleeve nut 803. According to a further aspect, the second end 705 is configured to cooperate with a nut-grommet assembly 801.

FIG. 30 depicts an embodiment, wherein the second end 705 is configured to cooperate with a socket 534. As shown therein, the second end 705 is shaped according to the socket 534. FIG. 30 depicts the second end 705 in a cup shape.

The socket 534 located at the second end 705 cooperates with a ball stud 110 that extends axially from the coupling member 700. The socket 534 is provided with a ball cooperating surface 535 and a socket outer surface 536. The ball cooperating surface 535 is generally perpendicular to the ball cooperating surface 509 located on the first end 704 of the coupling member 700. The socket outer surface 536 of the socket 534 is shaped according to the second end 705 of the coupling member 700.

The second end 705 shown in FIG. 30 is configured to cooperate with the seal 10. In the embodiment depicted, the second end 705 is provided with a seal acceptor 710.

The socket 534 is retained within the second end 705 via a ring 711. The ring 711 is dimensioned so that the ball stud 110 is able to pivot within the socket 534. The ring 711 is provided with an inner diameter 712 and an outer diameter 713. The inner diameter 712 is dimensioned according to the ball stud 110. As shown in FIG. 28, the inner diameter 712 is dimensioned so that the ball stud 110 is capable of pivoting within the socket 534. The outer diameter 713 is dimensioned according to the second end 705. The second end 705 is configured to accept the ring 711. As shown in FIG. 30, the second end 705 is provided with a ledge 714. The ledge 714 is dimensioned so that the ring 711 fits within the ledge 714 and extends over the socket 534.

The second end 705 is provided with a retaining member 715. The retaining member is crimped over the ring 711.

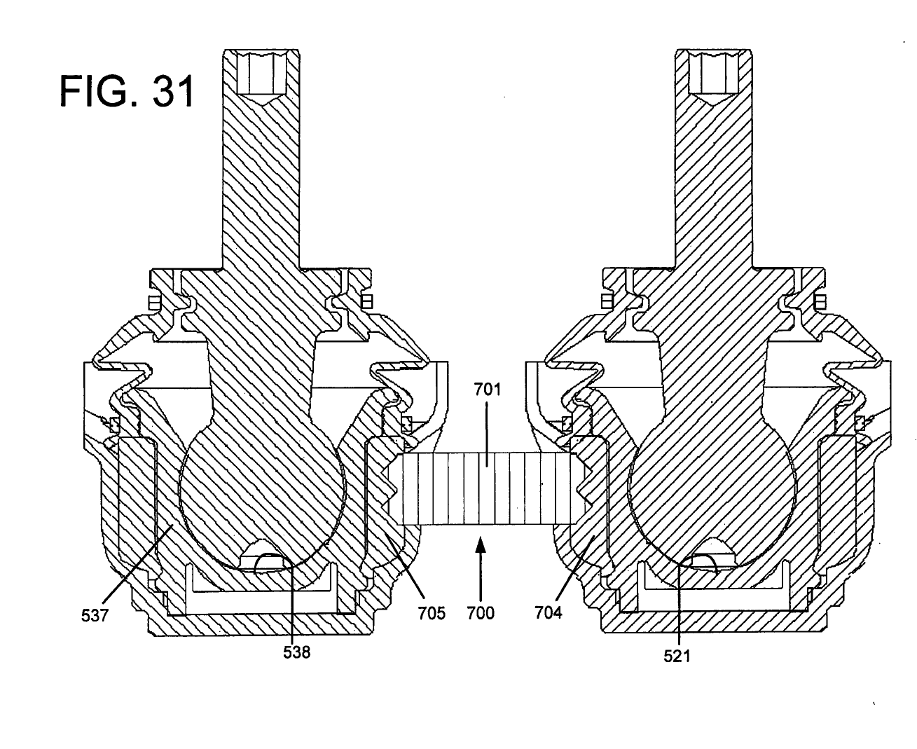

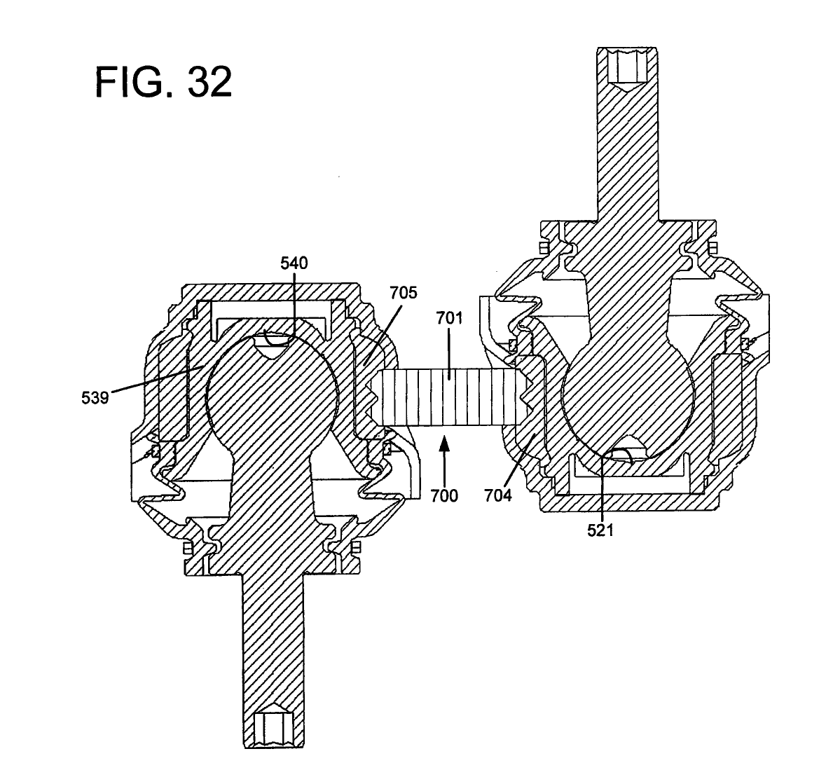

FIG. 31 depicts the second end 705 of the coupling member 700. As shown therein the second end 705 is provided with a socket 537 wherein the ball cooperating surface 538 faces substantially the same direction as the ball cooperating surface 521 located on the first end 704 of the coupling member 700. In another embodiment, as depicted in FIG. 32, the second end 705 is provided with a socket 539 wherein the ball cooperating surface 540 faces substantially the opposite direction as the ball cooperating surface 521 located on the first end 704 of the coupling member 700.

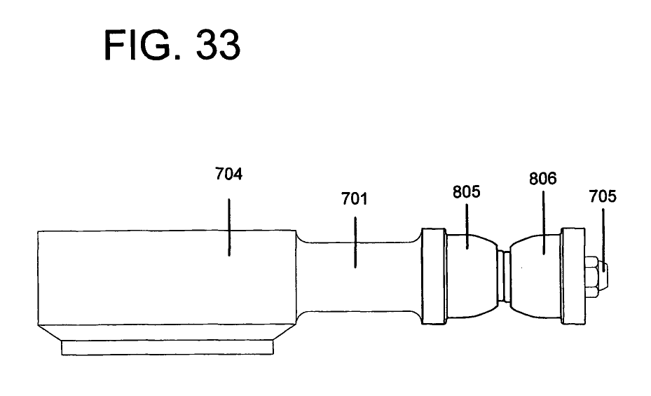

FIG. 33 depicts another embodiment, wherein the second end 705 cooperates with grommets 805, 806. As shown therein, the stem 701 includes a flange 716. Also shown therein, the second end 705 is provided with a plurality of grommets 805, 806. The second end 705 is configured to cooperate with the grommets 805, 806.

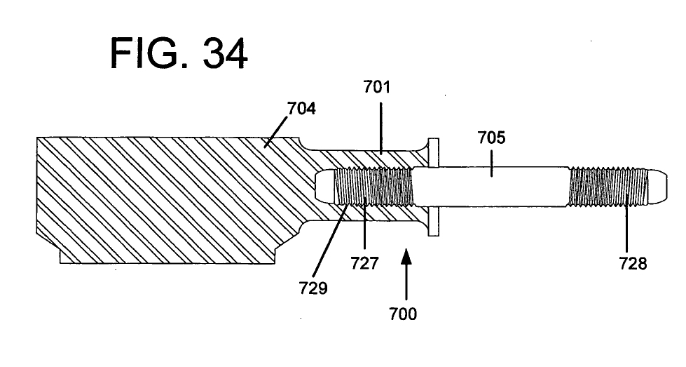

As shown in FIG. 34, the second end 705 is cylindrical in shape and provided with threads 727, 728. Threads 728 are configured to fasten with threads on a nut. As shown in FIG. 34, threads 727 are configured to fasten within threads 729 the stem 701. Advantageously, threads 727 couple the second end 705 of this embodiment to the stem 701.

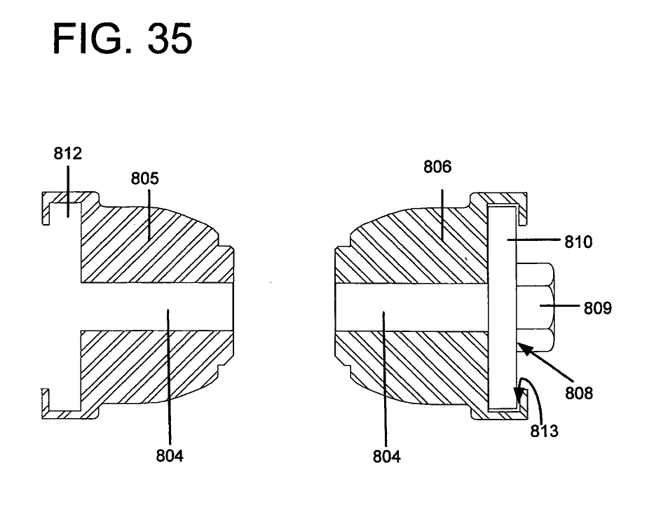

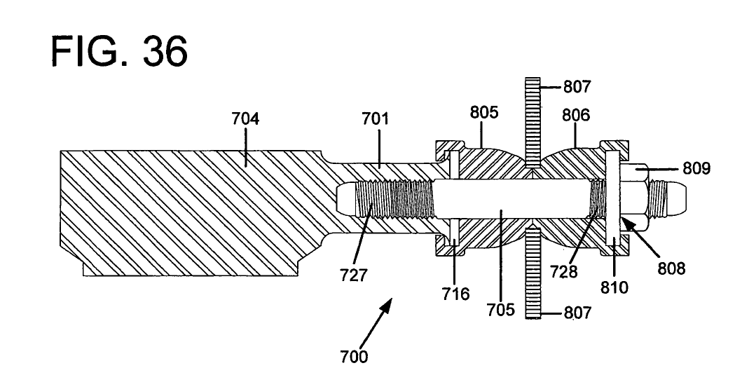

The grommets 805, 806 are molded of an elastomeric material, such as natural rubber, synthetic rubber, urethane, thermoplastic rubber, polyurethane, or the like. The grommets 805, 806 are configured to slide over the second end 705. As shown in FIG. 35, the grommets 805, 806 each define a passage 804, which is dimensioned according to the second end 705. The passage 804 is preferably dimensioned to have a diameter which is greater than the diameter of the second end 705. Also shown therein, grommets 805, 806 also define grooves 812, 813, respectively. Groove 812 is configured to capture the flange 716 (shown in FIG. 36), such as, for example, by being snap fit over the flange 716. Groove 813 is configured to capture an annular disc 810, such as, for example, by being snap fit over the annular disc 810. As shown in FIG. 35, the disc 810 is a component of a nut-disc assembly 808, which is provided with a rotatably associated nut 809 and annular disc 810.

Referring now to FIG. 36, the grommets 805, 806 are positioned to engage an arm 807. The presently preferred embodiment is provided with a first grommet 805 and a second grommet 806. The first grommet 805 abuts a portion of the coupling member 700, preferably the flange 716. Advantageously, the first grommet 805 is snap fitted to the flange 716. The second grommet 806 abuts a fastener, such as a nut. In the presently preferred embodiment, the fastener is a nut-disc assembly 808, which is provided with a nut 809 and an annular disc 810. As shown in FIG. 36 the second grommet 806 is snap fitted to the annular disc 810. To prevent loosening, the nut-disc assembly 808 depicted in FIG. 36 is provide with a nylon insert. While the preferred embodiment is provided with a nut-disc assembly 808, in an alternative embodiment a flanged nut is used.

Alternatively, the second end 705 is configured to cooperate with a nut-grommet assembly 801. Referring now to FIG. 45, a nut-grommet assembly 801 is depicted. As shown therein, the nut-grommet assembly 801 is provided with a sleeve nut 803 and a grommet 802. Also shown therein, the sleeve nut 803 is provided with a tubular portion 811, a head 812, which is preferably cup-shaped, and a free end 815.

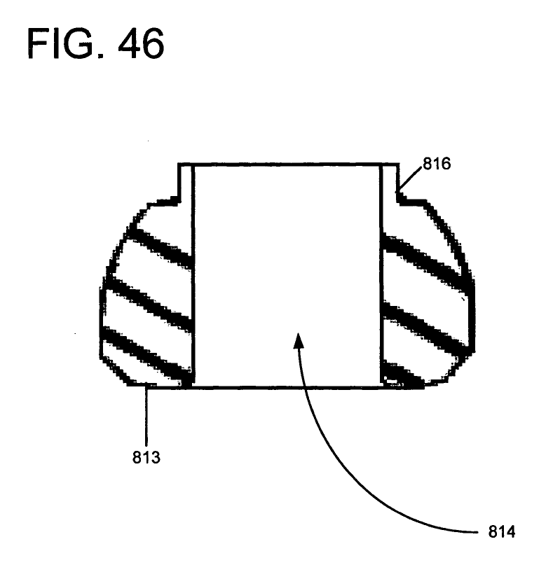

FIG. 46 depicts the grommet 802 defining a passage 814. The passage 814 is dimensioned to accommodate the tubular portion 811 of the sleeve nut 803. The passage 814 is dimensioned to be smaller than the outer diameter of the tubular portion 811, so that the grommet 802 resiliently grips the sleeve nut 803. FIG. 46 also depicts the grommet 802 provided with a arm cooperating surface 816, which is configured to cooperate with an arm 807, and a head cooperating surface 813. The head cooperating surface 813 is shaped to seat against the head 812 on the sleeve nut 812. However, in an alternative embodiment, the grommet 802 defines a passage 814 having a groove located therein, which captures the head 812 of the sleeve nut 803, such as, for example, by being snap fit over the head 812 of the sleeve nut 803.

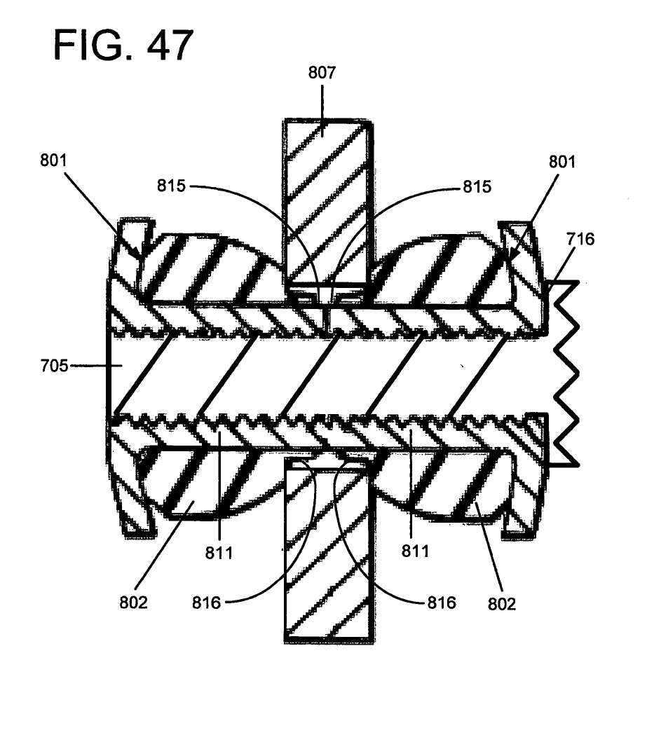

As shown in FIG. 45, when the grommet 802 is located on the sleeve nut 803, the free end 815 of the tubular portion 811 on the sleeve nut 803 protrudes slightly beyond an arm cooperating surface 816 of the grommet 802. Advantageously, as shown in FIG. 47 when a pair of nut-grommet assemblies 801 are threaded onto the second end 705, the free ends 815 of the tubular portion 811 abut each other, whereby the arm cooperating surfaces 816 of the grommets 802, which engage an arm 807, are spaced from each other by a distance, which preferably just accommodates the thickness of an arm 807.

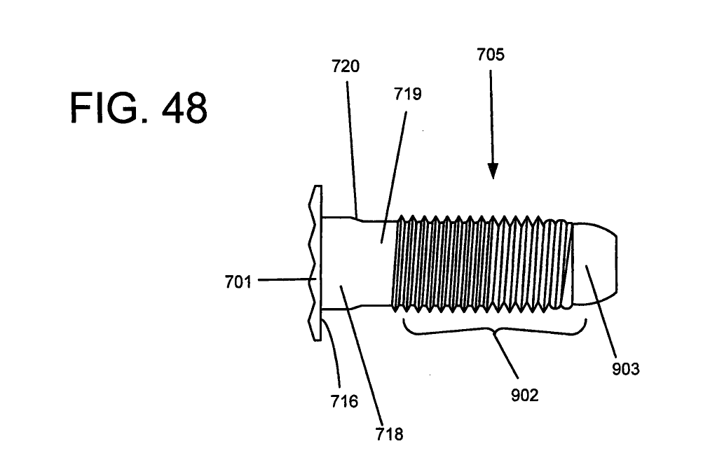

In an alternative embodiment, the second end 705 is provided with a thread configuration that reforms the threads on a nut, such as, for example, the threads on either a sleeve nut, flanged nut, or a nut in a nut-disc assembly. Alternatively, the second end 705 is configured to reform the threads 729 on the stem 701 (shown in FIG. 34). Turning now to FIG. 48 a second end 705 of an alternative embodiment of the present invention is depicted. The second end 705 comprises a metal, preferably aluminum. According to one aspect of the present invention, the metal is copper. According to another aspect of the present invention, the metal is iron.

In one aspect of the present invention, the metal is an alloy. According to another aspect of the present invention, the metal includes ferrous and non-ferrous materials. According to another aspect of the present invention, the metal is a steel. By way of example and not limitation, the steel is a stainless steel, such as A286. In one embodiment of the present invention the steel is a low carbon steel, such as 1010. In another embodiment of the present invention, the steel is a medium carbon steel, such as 1038, 1541, 4037, 8640, or 8650. In yet another embodiment of the present invention, the steel is a high carbon steel.

Those with skill in the art will also appreciate that the metal is a super alloy. According to one aspect of the present invention, the super alloy is bronze; according to another aspect of the present invention, the super alloy is a high nickel material. According to yet another aspect of the present invention, the second end 705 comprises martensitic material, such as 410 or 416. According to still another aspect of the present invention, the second end 705 comprises an austenitic material, such as 302HQ, 304, or 305. According to another aspect of the present invention, the metal is a ferritic material.

FIG. 48 depicts the second end 705 comprising a plurality of outer surfaces. As illustrated in FIG. 48, the second end 705 provides a suitable location for at least one of a plurality of outer surfaces. A lower cylindrical shaft element 901 of this embodiment includes a threaded section 902. Located adjacent to the threaded section 902 is an unthreaded section 903.

The outer surfaces of the present invention perform a plurality of functions. In the preferred embodiment, the threaded section 902 functions to couple the second end 705 to a nut, such as, for example, the sleeve nuts 803 of the nut and grommet sub-assembly 801, depicted in FIG. 45. This function is accomplished through the interaction of the threaded section 902 and the cooperating threads of a nut.

As shown in FIG. 48, the second end 902 comprises at least one of a plurality of shaft elements. According to one aspect of the present invention, the shaft element is cylindrical in shape. According to another aspect of the present invention, the shaft element is conical in shape. According to yet another aspect of the present invention, the shaft element is solid. According to still yet another aspect of the present invention, the shaft element is hollow.

FIG. 48 depicts the second end 705 comprising a plurality of shaft elements. The second end 705 includes an upper cylindrical shaft element 718, a lower cylindrical shaft element 719, and a conical shaft element 720. In the embodiment shown, the upper cylindrical shaft element 718 is joined to the lower cylindrical shaft element 719 via the conical shaft element 720.

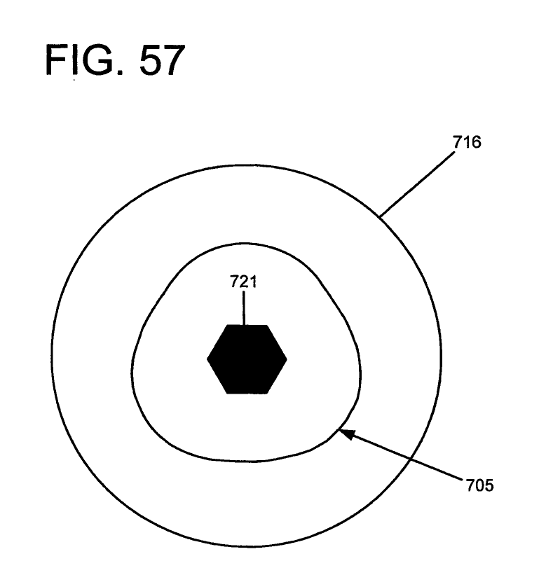

The second end 705 shown in FIG. 48 includes at least one torque transferring structure 721. As used herein, a torque transferring structure 721 is any structure which allows a torque to be transferred to or from the second end 705. As shown in FIG. 57, the torque transferring structure 721 is located on the second end 705 as an internal drive configured to cooperate with a tool, such as a wrench or a screw driver. In an alternative embodiment, the torque transferring structure 721 is located on the second end 705 as an external drive.

Those skilled in the art will appreciate that torque is transferred via a plurality of structures and that any such structure can be used without departing from the spirit of the present invention. Any structure which allows a torque to be transferred to or from the present invention is a torque transferring structure within the scope of the present invention.

As shown in FIG. 48, the second end 705 is provided with a plurality of outer surfaces. According to one aspect of the present invention, the outer surface is an unthreaded section 903. According to another aspect of the present invention, the outer surface is a threaded section 902.

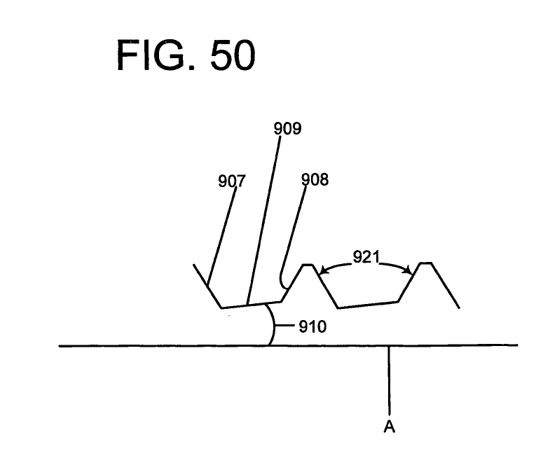

FIG. 47 depicts the threaded section 902 in greater detail. As shown therein, the threaded section 902 is provided with a plurality of thread configurations 904, 905, and 906. The threaded section 902 is provided with a locking thread 904. FIG. 50 depicts a cross-sectional view of a plurality of locking threads 904 in greater detail. As depicted in FIG. 50, the locking thread 904 is provided with a plurality of angled surfaces 907, 908. In the preferred embodiment, the locking thread 904 is provided with a first angled surface 907 and a second angled surface 908. Advantageously, the first angled surface 907 is at an angle 921 with respect to the second angled surface 908 ranging between 30° to 70°, preferably 60°.

Located between the first angled surface 907 and the second angled surface 908 is a root surface 909. The root surface 909 is at an angle 910 with respect to an imaginary horizontal line A, which runs along the axis of the second end 705. Preferably, the angle 910 is between 4° and 80°. The root surface 909 has a width that is greater than that found in a conventional thread and is configured so that the locking thread 904 converges to the flange 716.

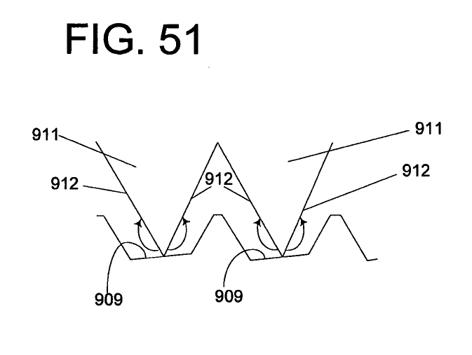

The locking thread 904 is configured to cooperate with the threads 911 of a nut. As the nut is torqued onto the second end 705, the root surfaces 909 within the locking threads 904 exert a force on the threads 911 of the nut. As depicted in FIG. 51, in cases where the threads 911 of the nut include a metal, the root surface 909 exerts a force upon the thread 911 of the nut so that the metal flows upward on a flank 912 of the thread 911. Alternatively, in a similar manner, the locking thread 904 is configured to reform the threads 729 on the stem 701 (shown in FIG. 34).

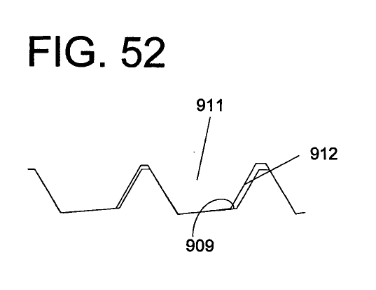

Referring now to FIG. 52, the threads 911 of the nut are re-formed so that the threads 911 generally conform to the configuration of the locking thread 904. As depicted in FIG. 52, the flank 912 on the thread 911 of the nut is re-formed so that it is in contact with at least one of the angled surfaces 907, 908 of the locking thread 904. FIG. 52 further depicts the threads 911 of the nut re-formed so that a greater surface area is in contact with the root surfaces 909 on the second end 705.

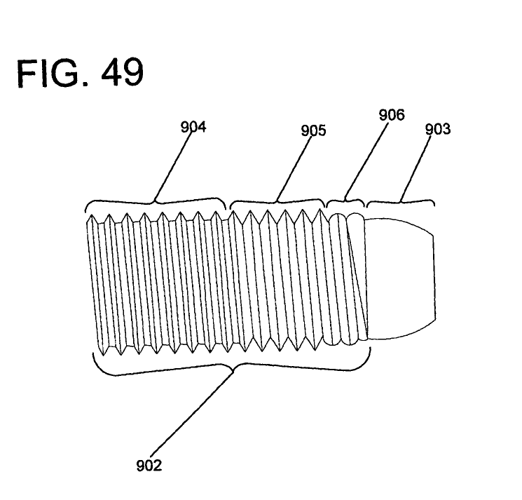

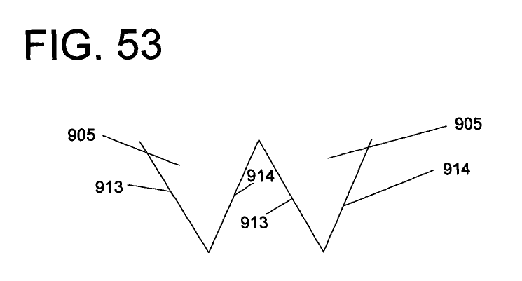

As depicted in FIG. 49, a plurality of Vee-shaped threads 905 are located adjacent to the plurality of locking threads 904. A cross-sectional view of a plurality of Vee-shaped threads 905 is depicted in greater detail in FIG. 53. As shown therein, a Vee-shaped thread 905 is provided with a first side 913 and a second side 914. The sides 913, 914 abut one another and are configured to form a Vee shape. The first side 913 is at an angle with respect to the second side 914, preferably ranging between 30° and 90°.

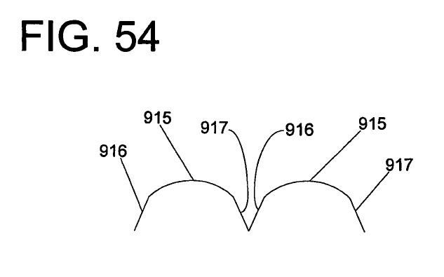

FIG. 49 further depicts a plurality of curved threads 906 located adjacent to the Vee-shaped threads 905. FIG. 54 depicts a cross-sectional view of a plurality of curved threads 906 in greater detail. According to one aspect of the present invention, the curved threads 906 are configured to prevent cross-threading. According to another aspect of the present invention, the curved threads 906 are configured to orient the threads 911 of a nut so that the threads 911 align with the threaded section 902 on the second end 705.

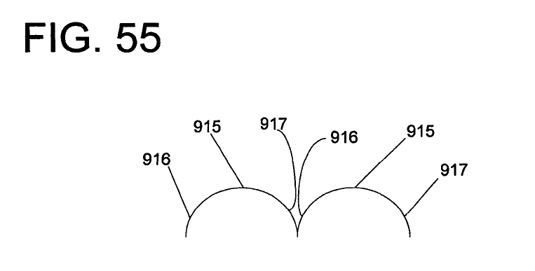

As shown in FIG. 54, the curved threads 906 are provided with at least one curved surface 915. In the preferred embodiment, the curved threads 906 are provided with a first side 916 and a second side 917. The curved surface 915 is located between the first side 916 and the second side 917. As shown in FIG. 54, the first side 916 is at angle with respect to the second side 917, preferably ranging between 30° and 90°. Alternatively, as shown in FIG. 55, the first and second sides 916, 917 are curved.

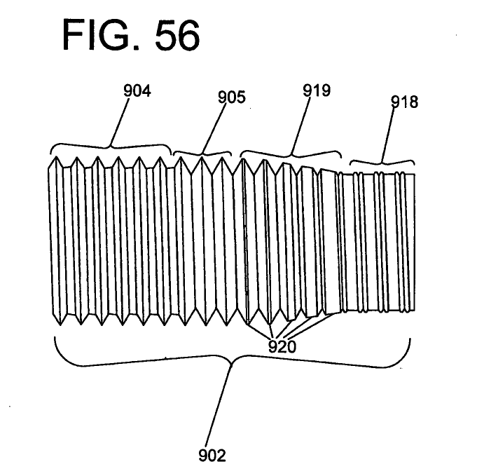

FIG. 56 depicts a cross-sectional view of an alternative threaded section 902. As shown therein, the threaded section 902 includes a plurality of guide threads 918. According to one aspect of the present invention, the guide threads 918 are configured to prevent cross-threading. According to another aspect, the guide threads 918 are configured to orient the threads 911 of a nut so that the threads 911 align with the threaded section 902 on the second end 705. As shown in FIG. 56, the guide threads 918 are located at an end of the second end 705 and are provided with a reduced diameter relative to the Vee-shaped threads 905.

A plurality of plateau threads 919 are located adjacent to the guide threads 918. As depicted in FIG. 56, the plateau threads 919 are provided with a plurality of plateaus 920. The plateaus 920 are shaped to prevent cross-threading and to orient the nut so that the threads 911 align with the threaded section 902 on the second end 705. In the embodiment depicted in FIG. 56, the plateaus 920 are conically or frusto-conically shaped, preferably to provide a ramped cross-sectional profile.

Referring now to FIG. 57, a bottom cross-sectional view of the second end 705 is shown. The second end 705 is advantageously provided with a trilobular shape; however a circular or ovular shape could be used. As further depicted in FIG. 57, at a terminal portion of the second end 705, there is provided a torque transferring structure 721 in the form of an internal drive, preferably hexagonal in shape.

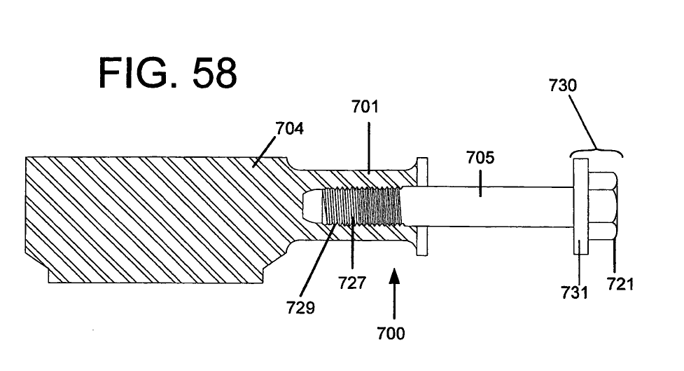

In an alternative embodiment, the torque transferring structure 721 is provided as an external drive. Referring now to FIG. 58, an alternative embodiment of a portion of the coupling member 700 is shown. As depicted therein, the second end 705 is provided with a head 730. Advantageously, the head 730 is provided with a flange 731; however, in an alternative embodiment, the head 730 is located adjacent to a disc, such as the disc 810 shown in FIG. 36. As shown in FIG. 58, the head 730 is provided with a torque transferring structure 721, which is in the form of an external drive and preferably hexagonal in shape.

While preferred embodiments of the invention have been described, it should be understood that the invention is not so limited, and modifications may be made without departing from the invention. The scope of the invention is defined by the appended claims, and all devices that come within the meaning of the claims, either literally or by equivalence, are intended to be embraced therein.

1. A joint assembly, comprising:
a) a first ball stud and a second ball stud, wherein at least one of the ball studs is provided with a shaft and a ball portion;
b) a first seal and a second seal, wherein at least one of the seals is provided with a securing member;
c) a first constricting element and a second constricting element, wherein at least one of the constricting elements is in the shape of a spring;
d) a first socket and a second socket, wherein at least one of the sockets is shaped to cooperate with the ball portion on one of the ball studs; and
e) a coupling member fabricated from a composite material that includes carbon fibers oriented to provide strength.

2. A joint assembly, comprising:
a) a first socket and a second socket;
b) a seal and a second seal;
c) a first constricting element and a second constricting element;
d) a first ball stud and second ball stud;
e) a coupling member fabricated from an alloy; and
f) wherein the coupling member is crimped around at least one of the sockets.

3. A joint assembly, comprising:
a) a first socket and a second socket;
b) a seal and a second seal;
c) a first constricting element and a second constricting element;
d) a first ball stud and second ball stud;
e) a coupling member fabricated from an alloy including aluminum; and
f) wherein at least one of the sockets extends radially from the coupling member.

4. A joint assembly, comprising:
a) a first socket and a second socket;
b) a seal and a second seal;
c) a first constricting element and a second constricting element;
d) a first ball stud and second ball stud wherein at least one of the ball studs is composed of a plurality of ball stud elements;
e) a coupling member fabricated from an alloy; and
f) wherein the coupling member is crimped around at least one of the sockets.

5. A joint assembly, comprising:
a) a seal provided with a first retaining surface and a second retaining surface;
b) a ball stud provided with a ball portion and a socket, wherein the socket is provided with a seal acceptor and a ball cooperating surface, wherein the ball portion of the ball stud is within the ball cooperating surface and a portion of the seal is within the seal acceptor;
c) a first and a second constricting element, wherein the first constricting element is held in place by the first retaining surface on the seal and the second constricting element is held in place by the second retaining surface on the seal; and
d) a coupling member provided with a stem, an end, and a retaining portion located on the end, wherein the retaining portion is crimped to the socket.

6. A method for manufacturing a joint assembly, comprising the steps of:
a) providing a socket;
b) providing a ball stud;
c) locating a ball portion of the ball stud within a ball cooperating surface of the socket;
d) providing a seal;
e) locating the seal radially about at least a portion of the ball stud and at least a portion of the socket;
f) providing a first constricting element and a second constricting element;
g) locating the first constricting element within a first retaining surface on the seal to secure the seal to the ball stud;
h) locating the second constricting element within a second retaining surface on the seal to secure the seal to the socket;
i) providing a coupling member that includes a stem, a first end, and a second end, wherein the first end includes a retaining portion;
j) crimping the retaining portion of the first end of the coupling member around at least a portion of the socket to secure the socket to the coupling member.

7. A ball joint, comprising:
a) a socket;
b) a ball stud, wherein a ball portion of the ball stud is located within a ball cooperating surface of the socket;
c) a seal located radially about at least a portion of the ball stud and at least a portion of the socket;
d) a first constricting element and a second constricting element, wherein:
i) the first constricting element is located within a first retaining surface on the seal and secures the seal to the ball stud;
ii) the second constricting element is located within a second retaining surface on the seal and secures the seal to the socket; and
e) a boot guard that includes a shield portion that extends radially about at least a portion of the seal.

8. The joint assembly according to claim 1, wherein at least one of the constricting elements is in the shape of a spring and provided with a first end that is secured to a second end.

9. A method for manufacturing a ball stud, comprising the steps of:
a) providing a first stud element that includes a ball portion;
b) providing a second stud element; and
c) welding the first and second stud elements together to provide a ball stud.

10. The method for manufacturing a ball stud according to claim 9, further comprising the steps of:
a) Providing a third stud element; and
b) crimping the second stud element around the third stud element to provide a surface that is adapted to receive a portion of a seal.
c)

11. The method for manufacturing a ball stud according to claim 9, wherein:
a) the first stud element is provided with a plurality of projections; and
b) the second stud element is provided with a coupling surface that defines a volume that is dimensioned to accommodate the volume of the material in the projections.

12. A method for manufacturing ajoint assembly, comprising the steps of:
a) providing a socket;
b) providing a ball stud;
c) locating a ball portion of the ball stud within a ball cooperating surface of the socket;
d) providing a seal;
e) locating the seal radially about at least a portion of the ball stud and at least a portion of the socket;
f) providing a first constricting element and a second constricting element;
g) locating the first constricting element within a first retaining surface on the seal to secure the seal to the ball stud;
h) locating the second constricting element within a second retaining surface on the seal to secure the seal to the socket;
i) providing a coupling member that includes a stem, a first end, and a second end, wherein:
i) the first end is secured to the socket; and
ii) the second end includes a threads for coupling with threads provided on the stem and threads provided on a fastener.

13. The method for manufacturing ajoint assembly according to claim 12, wherein the second end includes a first threaded portion that couples with the threads on the stem and a second threaded portion that couples with the threads on a fastener.
